(19) United States
(12) Patent Application Publication
(10) Pub. No.: US 2026/0233274 A1
(43) Pub. Date: Aug. 13, 2026

(54) HIGH-TENSILE STEEL HAVING IMPROVED HYDROGEN EMBRITTLEMENT RESISTANCE

(71) Applicant: THYSSENKRUPP STEEL EUROPE AG, Duisburg (DE)

(72) Inventors: Stefan BIENHOLZ, Bochum (DE); Volker MARX, Dortmund (DE); Aleksandra BARTELHEIMER, Dortmund (DE); Maria KÖYER, Dortmund (DE); Cássia CASTRO MÜLLER, Oberhausen (DE)

(21) Appl. No.: 19/150,439

(22) PCT Filed: Feb. 15, 2024
(86) PCT No.: PCT/EP2024/053832

§ 371 Date: Jul. 23, 2025

(30) Foreign Application Priority Data
Feb. 17, 2023 (EP) 23157148.0

(51) Int. Cl. B21B 15/00; B32B 15/01; C21D 6/00; C21D 8/04; C21D 9/48; C22C 21/02; C22C 38/00; C22C 38/02; C22C 38/04; C22C 38/06; C22C 38/44; C22C 38/46; C22C 38/48; C22C 38/50; C22C 38/52; C22C 38/54; C22C 38/58; C22C 38/60; C23C 2/02; C23C 2/12; C23C 2/40

(52) U.S. Cl. CPC B21B 15/005; B32B 15/012; C21D 6/004; C21D 6/005; C21D 6/007; C21D 6/008; C21D 8/0426; C21D 8/0436; C21D 8/0463; C21D 8/0478; C21D 9/48; C22C 21/02; C22C 38/001; C22C 38/002; C22C 38/02; C22C 38/04; C22C 38/06; C22C 38/44; C22C 38/46; C22C 38/48; C22C 38/50; C22C 38/52; C22C 38/54; C22C 38/58; C22C 38/60; C23C 2/0224; C23C 2/12; C23C 2/40

(57) ABSTRACT

A flat steel product for hot forming, to a formed shaped sheet metal part, and to processes for production of each, wherein the flat steel product and the shaped sheet metal part have improved resistance to hydrogen embrittlement, especially in conjunction with an aluminum-based anticorrosion coating.

The invention relates to a flat steel product for hot forming and to a process for producing such a flat steel product. The invention further relates to a shaped sheet metal part having improved properties and to a process for producing such a shaped sheet metal part from a flat steel product.

Where a “flat steel product” or else a “sheet metal product” is discussed hereinafter, this means rolled products such as steel strips or sheets, from which “sheet metal blanks” (also called blanks) are divided for the production of bodywork components, for example. “Shaped sheet metal parts” or “sheet metal components” of the type according to the invention have been produced from such sheet metal blanks; the terms “shaped sheet metal part” and “sheet metal component” are used synonymously here.

All figures relating to contents of the steel compositions that are reported in the present application are based on weight, unless explicitly stated otherwise. All indeterminate percentage figures associated with a steel alloy should therefore be regarded as figures in “% by weight”. With the exception of the figures relating to the residual austenite content of the microstructure of a shaped sheet metal part of the invention that are based on volume (reported in “% by volume”), figures relating to the contents of the various microstructure constituents are each based on the area of a section of a sample of the respective product (reported in area percent, “area %”), unless explicitly stated otherwise. Figures given in this text for the contents of the constituents of an atmosphere are based on volume (reported in “% by volume”).

Mechanical properties, such as tensile strength, yield point and elongation, that are reported here have been ascertained in the tensile test according to DIN EN ISO 6982-1, sample form 2 (Annex B Tab. B1) (version of 2020-06), unless explicitly stated otherwise. Bending angle is ascertained according to VDA standard 238-100.

The microstructure was determined on longitudinal sections that had been subjected to etching with 3% Nital (alcoholic nitric acid). The proportion of residual austenite was determined by x-ray diffractometry.

WO 2019/223854 A1 discloses a shaped sheet metal part and then process for producing such a shaped sheet metal part that has a tensile strength of at least 1000 MPa. This shaped sheet metal part consists of a steel composed of, as well as iron and unavoidable impurities, (in % by weight): 0.10-0.30% C, 0.5-2.0% Si, 0.5-2.4% Mn, 0.01-0.2% Al, 0.005-1.5% Cr, 0.01-0.1% P and optionally further optional elements, especially 0.005-0.1% Nb. In addition, the shaped sheet metal part comprises an anticorrosion coating containing aluminum.

EP 2 553 133 B1 likewise discloses a shaped sheet metal part and a process for producing such a shaped sheet metal part.

In the state as supplied, all manganese-boron steel goods are low in hydrogen. Their contents of diffusible hydrogen are in each case below the detection limit of currently 0.1 ppm. As a result, MnB steels in principle show only a low tendency to hydrogen-induced delayed cracking. In practice, however, it has been shown that hot forming of manganese-boron steels in relatively moist furnace atmospheres results in hydrogen enrichment in the steel substrate. The reason for this has been identified as a metal-water vapor reaction. This reaction occurs when the flat steel product, for the hot forming operation, is heated to relatively high temperatures in a heating furnace under a water vapor-containing atmosphere. The water vapor in the furnace atmosphere reacts at the material surface to form hydrogen and a metal oxide. The hydrogen formed diffuses into the steel material and can then lead to delayed failure therein in that it becomes preferentially concentrated in regions of high intrinsic tensile stress. If a locally very high hydrogen concentration is attained, this weakens the bond at the grain boundaries of the steel substrate structure to such an extent as to result in a crack along the grain boundary in use owing to the stress that occurs.

Ingress of hydrogen as a result of the surface reaction in the furnace is frequently avoided by using dewpoint control devices. The aim here is to limit the supply of water vapor in the furnace atmosphere.

EP 2 993 248 B1, in the case of flat steel products with an aluminum-based anticorrosion coating, discloses using an addition of alkali metals or alkaline earth metals, which very quickly form a protective oxide layer on the surface and hence prevent the surface reaction with water vapor. There is thus less production of free hydrogen that can diffuse into the steel substrate.

In addition, there is corrosion in the typical automotive use of the shaped sheet metal parts. This is especially the case with uncoated substrates. This corrosion likewise gives rise to hydrogen, which diffuses into the steel material, where it can lead to delayed failure in that it becomes preferentially concentrated in regions of high intrinsic tensile stress. If a locally very high hydrogen concentration is attained, this weakens the bond at the grain boundaries of the steel substrate structure to such an extent as to result in a crack along the grain boundary in use owing to the stress that occurs.

It is an object of the present invention to further reduce the free hydrogen content in shaped sheet metal parts, especially also in the case of uncoated substrates.

It is a further object of the present invention to reduce susceptibility to hydrogen embrittlement under corrosion.

This object is achieved by a flat steel product for hot forming, comprising a steel substrate composed of steel consisting of, as well as iron and unavoidable impurities, (in % by weight):
C: 0.25-0.8%,
Si: 0.01-2.0%,
Al: 0.001-1.0%,
B: 0.0005-0.01%,
P: ≤0.03%,
S: ≤0.02%,
N: ≤0.03%,
Sn: ≤0.03%,
As: ≤0.01%,
Sb: ≤0.02%,
   at least one of the elements in the group comprising Ti, Nb and V, with the proviso that the contents are as follows:
Ti: 0.008-0.10%,
Nb 0.01-0.07%,
V: 0.01-0.4%,
   and optionally one or more of the elements “Cr, Mn, Co, Cu, Mo, Ni, Ca, W, Ce, La” in the following contents:
Cr: 0.01-1.0%,
Mn: 0.01-3.5%,
Co: 0.05-1.0%,
Cu: 0.01-0.2%,
Mo: 0.002-1.0%,
Ni: 0.01-2.0%,
Ca: 0.0005-0.01%,
W: 0.001-1.0%,
Ce+La: 0.01-0.03%,
   where a degree of dispersion D₁ of precipitates in the near-surface third of the steel substrate is subject to the following condition:

$$25 \cdot {10}^{- 6} \frac{1}{nm} < {D}_{1} < 5 \cdot {10}^{- 3} \frac{1}{nm}$$

The degree of dispersion D₁ of precipitates is defined here as the ratio of area proportion of the precipitates in the metallographic section to the diameter of the precipitates, where the area proportion of the precipitates is the ratio of the total area of the precipitates in a measurement field to the size of the measurement field. The diameter is the average diameter over the measurement field.

According to the invention, the precipitates act as traps for the free hydrogen. Free hydrogen penetrating from the outside is thus localized at the precipitates. Consequently, a high concentration in regions with high intrinsic tensile stress is avoided. It has been shown that this effect virtually no longer exists when dispersion D₁ is too low. This means that the precipitates are too large and/or the proportion of precipitates is too small. There is then insufficient specific interface area between precipitates and substrate to effectively localize hydrogen. If, on the other hand, dispersion D₁ is too large, the precipitates themselves lead to a reduction in mechanical durability. This is caused by a retroactive force of the precipitates on the movement of dislocations in the crystal, called Zener drag. This Zener drag is directly proportional to dispersion D₁. The dislocation movement in turn causes plastic deformation and hence also directly influences the attainable bending angle. For example, there is a distinct reduction in the bending angle. In particular, dispersion D₁ is at least

$$35 \cdot {10}^{- 6} \frac{1}{nm} ,$$

more preferably at least

$$15 \cdot {10}^{- 5} \frac{1}{nm} .$$

Further preferably, dispersion D₁ is not more than

$$2 \cdot {10}^{- 3} \frac{1}{nm} ,$$

especially not more than

$$9. \cdot {10}^{- 4} \frac{1}{nm} .$$

The distribution of the precipitates and hence dispersion D₁ is measured with the aid of electron micrographs in combination with x-ray microanalysis (TEM and EDX) using carbon extraction replicas. The carbon extraction replicas are created using longitudinal sections. The magnification of the measurement is between 10 000× and 200 000×. These images can be used to calculate the average diameter and the area proportion of the precipitates in the measurement field using computer-aided image analysis. 5 measurement fields are measured for this purpose. The results of the 5 measurement fields are then averaged. The size of the measurement fields depends on the chosen magnification and ranges from 18.5 μm×14.5 μm at 10 000× magnification to 0.925 μm×0.725 μm at 200 000× magnification.

For example, dispersion can be determined by the following steps:
producing carbon extraction replicas of a longitudinal section of the flat steel product or shaped sheet metal part
determining the average diameter and area proportion of the precipitates in 5 different measurement fields of size 1.85 μm×1.45 μm by means of TEM and computer-aided image analysis at a magnification of 100 000×
calculating dispersion in each of the 5 measurement fields from the average diameter and the area proportion
determining the dispersion of the flat steel product or shaped sheet metal part as an average of the dispersion over the 5 measurement fields

For dispersion D₁ of flat steel product or shaped sheet metal part, the 5 measurement fields are positioned in the near-surface third of the steel substrate.

For dispersion D₂ in the alloy layer of the shaped sheet metal part, as elucidated later on, the corresponding measurement procedure applies, except that the 5 measurement fields are positioned in the alloy layer.

The precipitates are in particular carbides and/or carbonitrides of one or more of the elements from the group of vanadium, titanium, niobium, chromium and molybdenum. The elements vanadium, titanium and niobium are called microalloy elements and have an effect even in the smallest amounts.

The near-surface third of the steel substrates is the region of the steel substrate which is at a distance from a surface of the steel substrate that corresponds to not more than one third of the thickness of the steel substrate. This means that the steel substrate is conceptually divided into three slices of equal thickness parallel to the surface. The middle slice then contains the central region of the steel substrate including the center plane. The other two slices are each bounded by one of the two surfaces of the steel substrate. These two slices form the two near-surface thirds of the steel substrate.

Carbon (“C”) is present in the steel substrate of the flat steel product in contents of 0.25-0.8% by weight. C contents set at such a level contribute to hardenability of the steel in that they delay ferrite and bainite formation and stabilize the residual austenite in the microstructure. A carbon content of at least 0.06% by weight is required in order to achieve sufficient hardenability and associated high strength.

However, high C contents can adversely affect weldability. In order to improve weldability, the carbon content can be adjusted to not more than 0.5% by weight, preferably to not more than 0.50% by weight, more preferably 0.45% by weight, preferably not more than 0.38% by weight, in particular not more than 0.35% by weight.

In order to be able to utilize the positive effects of the presence of C in a particularly reliable manner, C contents of at least 0.28% by weight, preferably at least 0.30% by weight, in particular at least 0.31% by weight, preferably at least 0.32% by weight, are envisaged. With these contents, observing the further provisions of the invention, tensile strengths of the shaped sheet metal part of at least 1500 MPa, in particular at least 1750 MPa, can be reliably achieved after hot press forming.

Silicon (“Si”) is used to further increase the hardenability of the flat steel product and the strength of the press-hardened product via solid solution strengthening. Silicon also enables the use of ferro-silico-manganese as alloying agent, which has a beneficial effect on production costs. Silicon is present in the steel substrate of the flat steel product in contents of 0.01-2.0% by weight, in particular in contents of 0.02-2.0% by weight. A hardening effect is already established over and above an Si content of 0.05% by weight. A significant rise in strength occurs over and above an Si content of at least 0.15% by weight, especially at least 0.20% by weight. Si contents above 0.65% by weight have a disadvantageous effect on coating characteristics, especially in the case of Al-based coatings. Si contents of not more than 0.55% by weight, especially not more than 0.30% by weight, are preferably established in order to improve the surface quality of the coated flat steel product.

Aluminum (“Al”) is known to be added as a deoxidant in the production of steel. Its content in the steel substrate is at least 0.001% by weight, in particular at least 0.01% by weight, in particular at least 0.02% by weight, preferably at least 0.11% by weight, in particular at least 0.15% by weight. The maximum content of aluminum is 1.0% by weight, preferably not more than 0.7% by weight, in particular not more than 0.25% by weight. In particular embodiments, the maximum aluminum content is 0.10% by weight, preferably not more than 0.05% by weight. Reliable binding of the oxygen present in the steel melt requires at least 0.01% by weight of Al. Furthermore, Al may additionally be used for binding of contents of N that are unwanted but unavoidable for production-related reasons. Comparatively high aluminum contents have been avoided to date since the Ac3 temperature also moves upward with the aluminum content. This has an adverse effect on austenitization, which is important for hot forming. However, it has been shown that elevated aluminum contents surprisingly lead to positive effects in connection with an aluminum-based anticorrosion coating.

It has been found that, surprisingly, increasing the aluminum content (“Al”) in the steel substrate to the lower limits described or higher can achieve a distinct reduction in pore formation on coating with an aluminum-based anticorrosion coating and subsequent hot forming. Especially in the transition region between steel substrate and anticorrosion coating, the locally higher aluminum consumption in the case of formation of denser iron aluminide compounds can be at least partly compensated for by the aluminum content of the steel substrate, such that the formation of pores, especially a band of pores, is suppressed.

In the case of an excessively high Al content, especially in the case of contents of more than 1.0% by weight of Al, there is a risk that Al oxides will form at the surface of a product manufactured from steel material alloyed in accordance with the invention, which would worsen wetting characteristics in the hot dip coating operation. Moreover, in the case of relatively high Al contents, the formation of nonmetallic Al-based inclusions is favored, which, as coarse inclusions, have an adverse effect on crash characteristics. Therefore, the Al content is preferably chosen below the upper limits already mentioned.

Furthermore, the steel comprises at least one of the elements in the group comprising Ti, Nb and V. This means that the steel contains at least one of the elements Ti, Nb or V. The steel may also preferably contain two elements from the group (Ti, Nb or Ti, V or Nb, V) or, in particular, all three elements from the group (Ti, Nb and V). The limits detailed below with their preferred ranges are in any case applicable to the contents of the three elements.

The microalloy elements vanadium, niobium and titanium all form precipitates that contribute to grain refinement and serve as traps for free hydrogen. Because of their different solubilities, however, the precipitates occur at different temperatures. Ti precipitates have the lowest solubility in austenite and therefore precipitate out even at very high temperatures and lower the grain growth of austenite. Nb is precipitated from moderate temperatures, and vanadium only below about 900° C. Vanadium thus leads to particularly fine precipitates. Otherwise, all three elements have the analogous mechanism. The mechanism is elucidated hereinafter by way of example with reference to niobium. The same applies to vanadium and titanium.

The niobium content, especially in the process described hereinafter for production of a flat steel product for hot forming having an anticorrosion coating, leads to a distribution of niobium carbides and niobium carbonitrides that leads to a particularly fine hardening microstructure in the subsequent hot forming operation. During the cooling after the hot dip coating operation, the coated flat steel product is kept within a temperature range of 400° C. and 300° C. for a certain period of time. Within this temperature range, there is still a certain diffusion rate of carbon within the steel substrate, while thermodynamic solubility is very low. Carbon thus diffuses to and collects at lattice defects. Lattice defects are especially caused by dissolved niobium atoms, which expand the atomic lattice by virtue of their much higher atomic volume and hence increase the size of tetrahedral and octahedral gaps in the atomic lattice, such that the local solubility of C is increased. Consequently, clusters of C and Nb arise in the steel substrate, and are then transformed to very fine precipitates in the form of niobium carbides and niobium carbonitrides in the subsequent austenitization step of hot forming and act as additional austenite grains. Therefore, the result is a refined austenite microstructure with relatively small austenite grains and hence also a refined hardness microstructure. Furthermore, these precipitates form traps for free hydrogen and hence promote the inventive resistance to hydrogen embrittlement.

This especially also relates to the ferritic interdiffusion layer that forms in the hot forming. The refined ferritic microstructure in the interdiffusion layer helps to reduce the tendency of induction of cracks under bending stresses, and the precipitates in the ferritic interdiffusion layer trap the free hydrogen before it can become concentrated within the substrate.

For the effect described above, the Nb content is at least 0.01% by weight, in particular at least 0.010% by weight. In particular execution variants, the niobium content is at least 0.04% by weight. The maximum niobium content is 0.07% by weight, in particular not more than 0.05% by weight, preferably 0.03% by weight.

The titanium content for the effect described above is at least 0.008% by weight of Ti, wherein in particular at least 0.010% by weight, preferably at least 0.015% by weight of Ti, should be added for sufficient availability. There is a distinct deterioration in cold rollability and recrystallizability over and above 0.10% by weight of Ti, and therefore any greater Ti contents should be avoided. In order to improve cold rollability, the Ti content may be limited preferably to 0.08% by weight, especially to 0.050% by weight, more preferably to 0.040% by weight, especially 0.020% by weight. Titanium additionally has the effect of binding nitrogen and hence making it possible for boron to display its greatly ferrite-inhibiting effect. Therefore, in a preferred further development, the titanium content is more than 3.42 times the nitrogen content in order to achieve sufficient binding of nitrogen.

For the effect described above, the V content is at least 0.01% by weight, in particular at least 0.02% by weight, preferably at least 0.04% by weight, in particular at least 0.10% by weight. For reasons of cost, not more than 0.4% by weight, preferably not more than 0.25% by weight, of vanadium is included in the alloy.

The elements Nb, V and Ti may also be present as impurities in the steel below the abovementioned minimum levels.

Boron (“B”) is included in the alloy in order to improve the hardenability of the flat steel product in that boron atoms or boron precipitates adjoining austenite grain boundaries reduce the grain boundary energy, which suppresses the nucleation of ferrite during press hardening. A distinct effect on hardenability occurs in the case of contents of at least 0.0005% by weight, preferably at least 0.0007% by weight, especially at least 0.0010% by weight, especially at least 0.0020% by weight. In the case of contents exceeding 0.01% by weight, by contrast, there is increased formation of boron carbides, boron nitrides or boron nitrocarbides, which in turn constitute preferred nucleation sites for the nucleation of ferrite and lower the hardening effect again. For that reason, the boron content is limited to not more than 0.01% by weight, preferably not more than 0.0100% by weight, preferably not more than 0.0050% by weight, especially not more than 0.0035% by weight, especially not more than 0.0030% by weight, preferably not more than 0.0025% by weight.

Phosphorus (“P”) and sulfur (“S”) are elements that are introduced into the steel as impurities by iron ore and cannot be eliminated entirely in the industrial scale steelworks process. The P content and the S content should be kept as low as possible due to the residual deterioration in mechanical properties, for example notched impact resistance, with increasing P content or S content. Moreover, there is incipient embrittlement of the martensite over and above P contents of 0.03% by weight, and therefore the P content of a flat steel product of the invention is preferably limited to not more than 0.02% by weight, especially not more than 0.015% by weight. The S content of a flat steel product of the invention is limited to not more than 0.02% by weight, preferably not more than 0.0020% by weight, especially not more than 0.0010% by weight.

Nitrogen (“N”) is likewise present as an impurity in the steel in small amounts owing to the steel manufacturing process. The N content should be kept as low as possible and should be not more than 0.03% by weight, especially not more than 0.02% by weight. Especially in the case of alloys containing boron, nitrogen is harmful since the formation of boron nitrides prevents the transformation-retarding effect of boron, and therefore the nitrogen content in this case should preferably be not more than 0.010% by weight, especially not more than 0.007% by weight.

Further typical impurities are tin (“Sn”), arsenic (“As”) and antimony (“Sb”). The Sn content is not more than 0.03% by weight, preferably not more than 0.02% by weight. The As content is not more than 0.01% by weight, especially not more than 0.005% by weight. The Sb content is not more than 0.02% by weight, especially not more than 0.01% by weight, preferably not more than 0.005% by weight.

As well as the above-elucidated impurities P, S, N, Sn, As and Sb, it is also possible for further elements to be present in the steel as impurities. These further elements are consolidated as the “unavoidable impurities”. The content of these “unavoidable impurities” preferably adds up to not more than 0.2% by weight, preferably not more than 0.1% by weight. The optional alloy elements Cr, Mn, Co, Cu, Mo, Ni, V, Ti, Ca, W, Ce and La described above and hereinafter for which a lower limit is specified may also be present in the steel substrate as unavoidable impurities in contents below the respective lower limit. In that case, they are likewise counted among the “unavoidable impurities”, the total content of which is limited to not more than 0.2% by weight, preferably not more than 0.1% by weight.

Chromium, manganese, cobalt, copper, molybdenum, nickel, calcium, tungsten, cerium and lanthanum may optionally each be included in the alloy individually or in combination with one another in the steel of a flat steel product of the invention.

Chromium (“Cr”) suppresses the formation of ferrite and pearlite during accelerated cooling of a flat steel product of the invention and enables complete martensite formation even in the case of relatively low cooling rates, which achieves an increase in hardenability.

These stated effects are established over and above a content of 0.01% by weight, and a content of at least 0.10% by weight, preferably at least 0.20% by weight, has been found to be useful for reliable processing in practice. However, excessively high contents of Cr impair the coatability of the steel. Therefore, the Cr content of the steel of a steel substrate is limited to not more than 1.0% by weight, in particular not more than 0.75% by weight, preferably not more than 0.50% by weight.

Molybdenum (“Mo”) may optionally be added in order to improve process stability, since it distinctly slows ferrite formation. Over and above contents of 0.002% by weight, there is dynamic formation of molybdenum-carbon clusters up to and including ultrafine molybdenum carbides at the grain boundaries, which distinctly slow the mobility of the grain boundary and hence diffusive phase transformations. Moreover, molybdenum reduces grain boundary energy, which reduces the nucleation rate of ferrite. The Mo content is preferably at least 0.004% by weight, in particular at least 0.01% by weight, in particular at least 0.1% by weight, preferably at least 0.10% by weight. Because of the high costs associated with an alloy of molybdenum, the content should be not more than 1.0% by weight, in particular not more than 0.80% by weight, preferably not more than 0.30% by weight.

Chromium and molybdenum likewise form precipitates in a similar manner to the microalloy elements Nb, V and Ti, although the effect is smaller. Therefore, the addition of one or both of these elements in the above-specified amounts promotes the formation of precipitates with the dispersion of the invention.

Manganese (“Mn”) acts as a hardening element in that it significantly delays ferrite and bainite formation. The manganese content is 0.01-3.5% by weight. In the case of manganese contents of less than 0.2% by weight, during press hardening, significant proportions of ferrite and bainite are formed even in the case of very rapid cooling rates, which should be avoided. Mn contents of at least 0.7% by weight, preferably at least 0.8% by weight, in particular of at least 0.9% by weight, more preferably of at least 1.10% by weight, are advantageous when a martensitic microstructure is to be ensured, especially in regions of relatively high forming. Manganese contents of more than 3.5% by weight have an adverse effect on processing properties, and therefore the Mn content of flat steel products of the invention is limited to not more than 3.5% by weight, preferably not more than 2.5% by weight. Weldability in particular is greatly restricted, and therefore the Mn content is limited preferably to not more than 1.6% by weight and especially to 1.30% by weight. Manganese contents of not more than 1.6% by weight are additionally also preferred for economic reasons. In some embodiments, the manganese content is limited to not more than 0.80% by weight, in particular not more than 0.70% by weight.

Cobalt (“Co”) can be used as an optional alloy element to increase strength. For this purpose, Co contents of at least 0.05% by weight of the steel product of the invention should be added. In the case of Co contents of preferably at least 0.10% by weight, the strength-increasing character of the Co is particularly pronounced. However, Co, over and above certain concentrations, can reduce hardenability. At contents above 0.5% by weight, the adverse effect of Co increases noticeably, and so this value is not exceeded. In order not to adversely affect the toughness properties of the flat steel product of the invention, Co contents preferably of not more than 0.4% by weight and preferably not more than 0.2% by weight, in particular not more than 0.15% by weight, are observed. Below 0.01% by weight, cobalt can occur as an unavoidable impurity in the steel substrates.

Copper (“Cu”) may optionally be included in the alloy in order to increase hardenability in the case of additions of at least 0.01% by weight, preferably at least 0.010% by weight, especially at least 0.015% by weight. In addition, copper improves the resistance to atmospheric corrosion of uncoated sheets or cut edges. In the case of an excessively high Cu content, there is a distinct deterioration in hot rollability owing to low-melting Cu phases at the surface, and therefore the Cu content is limited to not more than 0.2% by weight, preferably not more than 0.1% by weight, especially not more than 0.10% by weight.

Nickel (“Ni”) stabilizes the austenitic phase and may optionally be included in the alloy in order to reduce the Ac3 temperature and to suppress the formation of ferrite and bainite. Nickel additionally has a positive influence on hot rollability, especially when the steel contains copper. Copper worsens hot rollability. In addition, EP3175006A1 discloses that significant nickel contents can lead to a near-surface layer with elevated Ni content, which likewise hinders the penetration of free hydrogen. The measures described therein can therefore preferably be combined with the improvements elucidated here in order to further lower the free hydrogen content. Therefore, 0.01% by weight of nickel can be included in the steel alloy; the Ni content is preferably at least 0.010% by weight, in particular at least 0.020% by weight. For economic reasons, the nickel content should remain limited to not more than 2.0% by weight, preferably not more than 1.0% by weight, especially not more than 0.60% by weight. Further preferably, the Ni content is not more than 0.50% by weight.

Calcium (“Ca”) in steels serves for indentation of nonmetallic inclusions, especially of manganese sulfides. Rounded indentation distinctly reduces the adverse effect of the inclusions on hot formability, sustained strength and toughness. In order to utilize this effect in the case of a flat steel product of the invention as well, a flat steel product of the invention may optionally contain at least 0.0005% by weight of Ca, especially at least 0.0010% by weight, preferably at least 0.0020% by weight. The maximum Ca content is 0.01% by weight, especially not more than 0.007% by weight, preferably not more than 0.005% by weight. In the case of excessively high Ca contents, there is a growing probability that nonmetallic inclusions involving Ca will form, which worsen the purity of the steel and also the toughness thereof. For this reason, an upper limit in the Ca content of not more than 0.005% by weight, preferably not more than 0.003% by weight, should be observed.

Tungsten (“W”) may optionally be included in the alloy in contents of 0.001-1.0% by weight in order to slow ferrite formation. A positive effect on hardenability already arises in the case of W contents of at least 0.001% by weight. For reasons of cost, not more than 1.0% by weight, in particular not more than 0.30% by weight, of tungsten is included in the alloy.

Optionally, the steel in the flat steel product of the invention has a content of cerium (“Ce”) and lanthanum (“La”) of greater than 0.01% by weight. What is meant by the statement that Ce+La is greater or less than a particular value is that either cerium or lanthanum is present in the steel, or that cerium and lanthanum are present simultaneously, where the sum total of the contents of cerium and lanthanum in all three cases is greater or less than the value determined. Therefore,

$$Ce + La : 0.01 - 0.03 \% by weight$$

means that either cerium or lanthanum is present in the steel or both cerium and lanthanum are present, where the sum total of the contents of cerium and lanthanum is in the range of 0.01-0.03% by weight. The content of Ce+La is preferably at least 0.010% by weight, especially at least 0.015% by weight. Further preferably, the content of Ce+La is not more than 0.025% by weight. Cerium and lanthanum are chemically very similar and therefore firstly have the same effect in steel and secondly are analytically distinguishable from one another only with great difficulty. Therefore, it is appropriate to consider merely the sum of the contents of cerium and lanthanum. Therefore, reference is also occasionally made to “cerium/lanthanum” hereinafter when what is meant is the addition of cerium and/or lanthanum.

It has been found that even the addition of Ce+La in small amounts over and above 0.01% by weight has a positive effect on resistance to hydrogen embrittlement (and hence on bending characteristics). The corresponding addition results in formation of more efficient hydrogen traps. Studies have shown that this is caused by effects including the formation of spheroidal oxysulfides of Ce and/or La (e.g. Ce₂O₂S). The compounds of Ce and La already form at very high temperatures and are thermodynamically very stable. They additionally ensure the binding of oxygen and sulfur for small amounts of Al₂O₃, MnS and similar inclusions.

In the case of excessively high contents of Ce+La, there can be “clogging” of the immersed tube in the casting process. Therefore, the content of Ce+La is limited to 0.03% by weight.

In a preferred variant of the flat steel product, the elements Mo, Cr, Ti, V and Nb are present in the steel and the element contents are subject to the following condition:

$$0.03 < {( Mo \cdot Cr \cdot Ti \cdot V \cdot Nb )}^{\frac{C}{5}} < 0.4$$

The elements Mo, Cr, Ti, V, Nb are the essential precipitate formers. The geometric average contents (in % by weight) of these elements as reported here is a particularly suitable way of describing the superposition of properties that change in a concentration-dependent manner, following a linear relationship. Since, moreover, the carbon content is likewise important for the formation of carbides,

$${( Mo \cdot Cr \cdot Ti \cdot V \cdot Nb )}^{\frac{C}{5}}$$

is of particularly good suitability for description of carbide distributions. It has been found that particularly suitable carbide distributions are established when the abovementioned relationship is satisfied.

In a further preferred variant of the flat steel product, the element contents are subject to the following condition:

$$N i + C r \leq 1.1$$

Owing to health concerns and in particular the European Union REACH regulation, the levels of Ni and Cr should be kept low. Therefore, the above relationship is advantageously satisfied.

The flat steel product preferably comprises an anticorrosion coating on at least one side in order to protect the steel substrate from oxidation and corrosion in the hot forming operation and in the use of the shaped sheet metal part produced.

In a specific embodiment, the flat steel product preferably comprises an aluminum-based anticorrosion coating. This anticorrosion coating may have been applied on one or both sides of the flat steel product. “Both sides of the flat steel product” refer to the two opposite large faces of the flat steel product. The narrow faces are referred to as edges.

Such an anticorrosion coating is preferably created by hot dip coating of the flat steel product. This involves conducting the flat steel product through a liquid melt consisting of 0.1-15% by weight of Si, preferably more than 1.0% by weight of Si, optionally 2-4% by weight of Fe, optionally up to 5% by weight of alkali metals or alkaline earth metals, preferably up to 1.0% by weight of alkali metals or alkaline earth metals, and optionally up to 15% by weight of Zn, preferably up to 10% by weight of Zn, and optional further constituents, the contents of which are limited to a total of not more than 2.0% by weight, and aluminum as the balance. Preferably, the optional content of alkali metals or alkaline earth metals is at least 0.1% by weight.

In a preferred variant, the Si content of the melt is 0.5-3.5% by weight or 7-12% by weight, especially 8-10% by weight.

In a preferred variant, the optional content of alkali metals or alkaline earth metals in the melt comprises 0.1-1.0% by weight of Mg, especially 0.1-0.7% by weight of Mg, preferably 0.1-0.5% by weight of Mg. In addition, the optional content of alkali metals or alkaline earth metals in the melt may especially comprise at least 0.0015% by weight of Ca, especially at least 0.01% by weight of Ca. Further preferably, the optional content of alkali metals or alkaline earth metals in the melt consists of 0.1-1.0% by weight of Mg, especially 0.1-0.7% by weight of Mg, preferably 0.1-0.5% by weight of Mg, and optionally at least 0.0015% by weight of Ca, especially at least 0.01% by weight of Ca.

In the case of hot dip coating, iron diffuses out of the steel substrate into the liquid coating, such that the anticorrosion coating of the flat steel product on solidification especially has an alloy layer and an Al base layer.

The alloy layer lies atop and directly adjoins the steel substrate. The alloy layer is formed essentially from aluminum and iron. The alloy layer preferably consists of 25-50% by weight of Fe, 5-20% by weight of Si, optional further constituents, the contents of which are limited to a total of not more than 5.0% by weight, preferably 2.0% by weight, and aluminum as the balance. The optional further constituents especially include the other constituents of the melt (i.e. any alkali metals or alkaline earth metals, especially Mg and Ca) and the other components of the steel substrate in addition to iron.

In a further variant (variant with Si content in the melt of 0.5-3.5% by weight), the alloy layer consists of 25-50% by weight of Fe, 0.5-5.0% by weight of Si, optional further constituents, the content of which is limited to a total of not more than 5.0% by weight, preferably 2.0% by weight, and aluminum as the balance. The optional further constituents here too especially include the other constituents of the melt (i.e. any alkali metals or alkaline earth metals, especially Mg and Ca) and the other components of the steel substrate in addition to iron.

In a preferred variant of the flat steel product, the degree of dispersion D₂ of precipitates in the alloy layer is subject to the following condition:

$$25 \cdot {10}^{- 6} \frac{1}{nm} < {D}_{2} < 5 \cdot {10}^{- 3} \frac{1}{nm}$$

The precipitates are in particular carbides and/or carbonitrides of one or more of the elements from the group of vanadium, titanium, niobium, chromium and molybdenum.

As a result of the adjustment of the precipitates in the steel substrate of the flat steel product, there is likewise a corresponding degree of dispersion D₂ in the preferably ferritic alloy layer. Here too, the precipitates act as traps for the free hydrogen. Free hydrogen penetrating from the outside is thus localized at the precipitates. The free hydrogen thus accumulates in the alloy layer. This is preferably ferritic and hence softer than the steel substrate. Hydrogen embrittlement thus does not occur as quickly, since the free hydrogen accumulates in the softer alloy layer and does not enter the more brittle steel substrate.

The Al base layer lies atop and directly adjoins the alloy layer. The composition of the Al base layer preferably corresponds to the composition of the melt in the melt bath. This means that it consists of 1.0-15% by weight of Si, optionally 2-4% by weight of Fe, optionally up to 5% by weight of alkali metals or alkaline earth metals, preferably up to 1.0% by weight of alkali metals or alkaline earth metals, optionally up to 15% by weight of Zn, and optional further constituents, the contents of which are limited to a total of not more than 2.0% by weight, and aluminum as the balance. Preferred compositions of the Al base layer correspond to the preferred melt compositions.

In a preferred variant of the Al base layer, the optional content of alkali metals or alkaline earth metals comprises 0.1-1.0% by weight of Mg, especially 0.1-0.7% by weight of Mg, preferably 0.1-0.5% by weight of Mg. In addition, the optional content of alkali metals or alkaline earth metals in the Al base layer may especially comprise at least 0.0015% by weight of Ca, especially at least 0.1% by weight of Ca. Further preferably, the optional content of alkali metals or alkaline earth metals consists of 0.1-1.0% by weight of Mg, especially 0.1-0.7% by weight of Mg, preferably 0.1-0.5% by weight of Mg, and optionally at least 0.0015% by weight of Ca, especially at least 0.1% by weight of Ca.

In a further-preferred variant of the anticorrosion coating, the Si content in the alloy layer is lower than the Si content in the Al base layer.

The anticorrosion coating preferably has a thickness of 5-60 μm, especially of 10-40 μm. The coatweight of the anticorrosion coating is especially

$$30 - 360 \frac{g}{{m}^{2}}$$

in the case of double-sided anticorrosion coatings or

$$15 - 188 \frac{g}{{m}^{2}}$$

in the case of the single-sided variant. The coatweight of the anticorrosion coating is preferably

$$100 - 200 \frac{g}{{m}^{2}}$$

in the case of double-sided coatings or

$$50 - 100 \frac{g}{{m}^{2}}$$

for single-sided coatings. The coatweight of the anticorrosion coating is more preferably

$$120 - 180 \frac{g}{{m}^{2}}$$

in the case of double-sided coatings or

$$60 - 90 \frac{g}{{m}^{2}}$$

for single-sided coatings.

The thickness of the alloy layer is preferably less than 20 μm, more preferably less than 16 μm, more preferably less than 12 μm, especially less than 10 μm. The thickness of the Al base layer is found from the difference in the thicknesses of anticorrosion coating and alloy layer. The thickness of the Al base layer even in the case of thin anticorrosion coatings is preferably at least 1 μm.

In a preferred variant, the flat steel product comprises an oxide layer disposed atop the anticorrosion coating. The oxide layer lies in particular atop the Al base layer and preferably forms the outer conclusion of the anticorrosion coating.

The oxide layer consists especially to an extent of more than 80% by weight of oxides, where the majority of the oxides (i.e. more than 50% by weight of the oxides) is aluminum oxide. The oxide layer optionally includes, in addition to aluminum oxide, hydroxides and/or magnesium oxide alone or as a mixture. The remainder of the oxide layer not accounted for by the oxides and optionally present hydroxides preferably consists of silicon, aluminum, iron and/or magnesium in metallic form. For the optional embodiment with zinc as a constituent of the Al base layer, zinc oxide constituents are also present in the oxide layer.

The oxide layer of the flat steel product preferably has a thickness greater than 50 nm. In particular, the thickness of the oxide layer is not more than 500 nm.

In an alternative configuration, the flat steel product comprises a zinc-based anticorrosion coating. This anticorrosion coating may have been applied on one or both sides of the flat steel product. “Both sides of the flat steel product” refer to the two opposite large faces of the flat steel product. The narrow faces are referred to as edges.

Such a zinc-based anticorrosion coating preferably comprises 0.2-6.0% by weight of Al, 0.1-10.0% by weight of Mg, optionally 0.1-40% by weight of manganese or copper, optionally 0.1-10.0% by weight of cerium, optionally not more than 0.2% by weight of further elements, unavoidable impurities, and zinc as the balance. In particular, the Al content is not more than 2.0% by weight, preferably not more than 1.5% by weight. The Mg content is especially not more than 3.0% by weight, preferably not more than 1.0% by weight. The anticorrosion coating may be applied by hot dip coating or by physical gas phase deposition or by electrolytic methods.

The above elucidations relating to element contents and preferred limits thereof are correspondingly applicable to the process described hereinafter for production of a flat steel product, to the shaped sheet metal part and to the process for producing a shaped sheet metal part.

The process of the invention for producing a flat steel product for hot forming with an anticorrosion coating comprises the following steps:
a) providing a slab or thin slab which consists of steel consisting of, as well as iron and unavoidable impurities (in % by weight):
   C: 0.25-0.8%,
   Si: 0.01-2.0%,
   Al: 0.001-1.0%,
   B: 0.0005-0.01%,
   P: ≤0.03%,
   S: ≤0.02%,
   N: ≤0.03%,
   Sn: ≤0.03%,
   As: ≤0.01%,
   Sb: ≤0.02%,
at least one of the elements in the group comprising Ti, Nb and V, with the proviso that the contents are as follows:
   Ti: 0.008-0.10%,
   Nb: 0.01-0.07%,
   V: 0.01-0.4%,
and optionally one or more of the elements “Cr, Mn, Co, Cu, Mo, Ni, Ca, W, Ce, La” in the following contents:
   Cr: 0.01-1.0%,
   Mn: 0.01-3.5%,
   Co: 0.05-1.0%,
   Cu: 0.01-0.2%,
   Mo: 0.002-1.0%,
   Ni: 0.01-2.0%,
   Ca: 0.0005-0.01%,
   W: 0.001-1.0%,
   Ce+La: 0.01-0.03%;
b) through-heating the slab or thin slab at a temperature (T1) of 1100-1400° C.;
c) prerolling the through-heated slab or thin slab to give a preliminary strip having a preliminary strip temperature (T2) of 800-1200° C.;
d) hot rolling the preliminary strip to give a hot-rolled flat steel product by means of a rolling mill, where the local temperature of the preliminary strip is adjusted before and during the hot rolling of the preliminary strip such that the temperatures of the individual sections of the preliminary strip do not vary by more than 60 K in the course of hot rolling and where the final rolling temperature (T3) is 750-910° C.;
e) cooling the hot-rolled flat steel product to a coiling temperature (T4) of 500-670° C.;
f) coiling the hot-rolled flat steel product;
g) descaling the hot-rolled flat steel product;
h) optionally cold-rolling the flat steel product, where the degree of cold rolling is at least 30%;
i) annealing the flat steel product at an annealing temperature (T5) of 650-900° C.;
j) cooling the flat steel product to an intermediate temperature (T6) of 650-800° C., preferably 670-800° C.;
k) optionally coating the flat steel product having an anticorrosion coating that has been cooled to the intermediate temperature by hot dip coating in a melt bath having a melt temperature (T7) of 660-800° C., preferably 680-740° C.;
l) cooling the flat steel product to room temperature, where the first cooling period t_{MT} in the temperature range between 600° C. and 450° C. is more than 10 s, especially more than 14 s, and the second cooling period tur in the temperature range between 400° C. and 300° C. is more than 8 s, especially more than 12 s;
m) optionally skin pass rolling the flat steel product.

In step a), a slab or thin slab with a composition in accordance with the alloy specified in accordance with the invention for the flat steel product is provided. This is done by conventional continuous slab casting or thin slab casting.

In step b), the slab or thin slab is through-heated at a temperature (T1) of 1100-1400° C. If the slab or thin slab is to be cooled after the casting, it is first reheated to 1100-1320° C. for through-heating. The through-heating temperature should be at least 1100° C. in order to ensure good formability for the subsequent rolling process. Preferably, the through-heating temperature (T1) is at least 1200° C., preferably at least 1250° C. The through-heating temperature should be not more than 1320° C., preferably not more than 1300° C. This firstly avoids fractions of molten phases in the slab or semifinished slab. Secondly, it has been shown that the dispersion D₁ of the precipitates is too high when higher through-heating temperatures are used. Furthermore, a higher temperature leads to even further-increasing reactions with the environment (e.g. partial decarburization in the near-surface region). There is likewise grain growth in the slab, leading to poorer and more inhomogeneous properties of the product. In addition, the higher scaling that occurs would also reduce output.

In step c), the slab or thin slab is prerolled to a preliminary strip. In that case, the temperature of the preliminary strip (T2) at the end of the prerolling should be at least 800° C. in order that the intermediate product contains sufficient heat for the subsequent step of finish rolling. However, high rolling temperatures can also promote grain growth during the rolling operation, which has an adverse effect on the mechanical properties of the flat steel product. In order to minimize grain growth during the rolling operation, the temperature of the intermediate product at the end of the prerolling should not be more than 1200° C. The preliminary strip temperature (T2) is preferably at least 850° C. Further preferably, the preliminary strip temperature is at most 1150° C., in particular at most 1100° C., preferably at most 1050° C. In the context of this application, the preliminary strip temperature (T2) refers to the temperature of the start of the preliminary strip on entry into the (downstream) rolling mill.

In step d), the preliminary strip is rolled to a hot-rolled flat steel product by means of a rolling mill. The finish rolling preferably commences no later than 90 s after the end of the prerolling. Before and during the hot rolling of the preliminary strip, the local temperature of the preliminary strip should be set so that the temperatures of the individual sections of the preliminary strip vary by not more than 60 K in the hot rolling operation. The literature to date reports only a hot rolling temperature. This is either the temperature of the start of the preliminary strip in the hot rolling operation or an average temperature of the preliminary strip in the hot rolling operation. However, since the strips are of significant length, large temperature differentials may occur along the preliminary strip. Even if a preliminary strip uniformly heated to a particular temperature enters the rolling mill, only the start of the preliminary strip is rolled at that temperature. While the start of the preliminary strip is rolled, significant cooling will already occur in the upstream sections of the preliminary strip. This effect is known in principle and leads to an increase in the required rolling force during finish rolling owing to the decreasing temperature and hence rising strength. However, such variations are achievable in an unproblematic manner in modern rolling mills, and so there did not seem any need to compensate for this to date. However, it has been recognized in accordance with the invention that this effect can also affect final material properties. For instance, in the case of the well-known finish rolling of a homogeneously heated preliminary strip, a temperature gradient along the flat steel product (also referred to as finished strip) will inevitably arise after finish rolling. This is because the preliminary strip is much thicker before rolling and accordingly cools down more slowly than the finished strip after rolling. Thus, while the start of the strip is rolled first and then immediately cools down quickly as finished strip, the end of the strip is rolled last and therefore cools slowly until it is rolled. The start of the strip and the end of the strip are thus subject to a different temperature regime. This surprisingly affects the final characteristics of the entire strip. The reason is probably that the temperature distribution along the strip leads to a temperature gradient along the coil radius during subsequent coiling, which in turn affects the cooling behavior of the coil. The result is a distribution of the precipitates with a dispersion D₁ outside the desired range which is advantageous for reduction of the free hydrogen level.

The abovementioned problems are solved in accordance with the invention by adjusting the local temperature of the preliminary strip before and during the hot rolling of the preliminary strip in such a way that the temperatures of the individual sections of the preliminary strip vary by not more than 60 K in the hot rolling operation. This means the temperature of each section of the preliminary strip at the time at which this section is rolled.

This temperature control achieves the effect that each section of the preliminary strip, when rolled, is essentially at the same temperature. As a result, each section of the preliminary strip will also be subject to the same temperature regime from this point. As a result, the desired distribution of the precipitates is established.

The local setting of the temperature can be effected by various temperature control measures. Possible temperature control measures include:
thermal insulation of the preliminary strip upstream of the rolling mill, preferably by guiding the preliminary strip through an enclosed region,
section-by-section reheating of the preliminary strip.

The thermal insulation of the preliminary strip upstream of the rolling mill is preferably implemented by guiding the preliminary strip through an enclosed region. This involves thermal insulation of a region of the strip run upstream of the rolling mill by means of an enclosure in order to reduce cooling of the preliminary strip in this region. In the case of low cooling, the high thermal conductivity of the strip then leads to a relatively homogeneous temperature, such that the variation is less than 60 K. The enclosed region may be linear or consist of several linear segments. Alternatively, this can also be implemented in that the preliminary strip is first rolled up in a spiral shape and this spiral is kept within a thermal insulation in order to balance out temperature differences.

Section-by-section reheating of the preliminary strip can be achieved in particular as follows:
local, in particular inductive, reheating of the preliminary strip upstream of the rolling mill,
variation of the forming speed in the preliminary rolling or hot rolling operation, such that the energy introduced by the forming varies.

It is known that rolling not only reduces the thickness of a strip, but also introduces thermal energy locally. The thermal energy introduced depends on the forming speed in the rolling operation. Variation of the forming speed along the strip thus allows controlled introduction of more thermal energy into individual sections of the strip. In the present context, for example, the forming speed in the prerolling operation can thus be varied in order to apply a controlled temperature distribution that compensates for the subsequent cooling behavior and in this way ensures that the temperatures do not vary too much in the hot rolling operation. The forming speed can likewise be varied directly in the hot rolling operation in order to compensate for the previous cooling behavior.

The thermal insulation of the preliminary strip upstream of the rolling mill, the local reheating of the preliminary strip upstream of the rolling mill and the variation of the forming speed in the prerolling operation achieve the effect that the preliminary strip has a relatively homogeneous temperature even on entry into the rolling mill. Thus, the temperatures of the individual sections of the preliminary strip vary by not more than 60 K on entry into the rolling mill. This means the local temperature along the preliminary strip as it passes by a fixed point, namely the entry into the rolling mill.

By contrast, variation of the forming speed in the hot rolling operation achieves the effect that the inhomogeneous temperature distribution is at least partly compensated for directly in the hot rolling operation.

The final rolling temperature (T3), i.e. the temperature of the completely hot-rolled flat steel product at the end of the hot rolling operation, is 750-910° C. The final rolling temperature (T3) is preferably at least 800° C., in particular at least 825° C. The final rolling temperature is limited to values of not more than 910° C. in order to prevent coarsening of the austenite grains. Moreover, final rolling temperatures of not more than 910° C. are of relevance for process technology purposes in order to establish coiling temperatures (T4) of less than 670° C.

In a preferred variant, the T2/T3 ratio of the preliminary strip temperature T2 to the final rolling temperature T3 is at least 1.0. Further preferably, the T2/T3 ratio is at most 1.35, preferably at most 1.25, in particular at most 1.15.

In the subsequent step e), the hot-rolled flat steel product is cooled to a coiling temperature (T4) of 500-670° C.

Step f) envisages coiling of the hot-rolled flat steel product. For this purpose, the flat steel product, after the hot rolling, is cooled down to a coiling temperature (T4), in particular within less than 50 s. The cooling medium used for this purpose may, for example, be water, air or a combination of the two. The coiling temperature (T4) should not exceed 670° C., preferably 650° C. There is in principle no lower limit to the coiling temperature. However, coiling temperatures of at least 550° C. have been found to be favorable for cold rollability. Subsequently, the coiled flat steel product is cooled down to room temperature in a conventional manner under air.

In step g), the hot-rolled flat steel product is descaled in a conventional manner by pickling or by another suitable treatment.

The descaled hot-rolled flat steel product, prior to the annealing treatment in step h), may optionally be subjected to cold rolling in order, for example, to meet higher demands on the thickness tolerances of the flat steel product. The degree of cold rolling (DCR) should be at least 30% in order to introduce sufficient deformation energy into the flat steel product for rapid recrystallization. The degree of cold rolling DCR is understood to mean the quotient of the decrease in thickness on cold rolling ΔdCR divided by the hot strip thickness d:

$$DCR = Δ dCR / d$$

with ΔdCR=decrease in thickness on cold rolling in mm and d=hot strip thickness in mm, where the decrease in thickness ΔdCR is calculated from the difference in thickness of the flat steel product before cold rolling relative to the thickness of the flat steel product after cold rolling. The flat steel product before cold rolling is usually a hot strip of thickness d. The flat steel product after cold rolling is usually also referred to as cold strip. The degree of cold rolling may in principle assume very high values of more than 90%. However, degrees of cold rolling of not more than 80% have been found to be favorable for avoidance of strip cracks.

The continuation of the process is described hereinafter, firstly in a first variant in which the flat steel product is coated:

In step i), the flat steel product is subjected to an annealing treatment at annealing temperatures (T5) of 650-900° C. For this purpose, the flat steel product is first heated to the annealing temperature within 10 to 120 s and then kept at the annealing temperature for 30 to 600 s. The annealing temperature is at least 650° C., preferably at least 720° C. Annealing temperatures above 900° C. are not desirable, for economic reasons.

In step j), the flat steel product, after the annealing, is cooled down to an intermediate temperature (T6) in order to prepare it for the subsequent coating treatment. The intermediate temperature T6 can also be referred to as dipping temperature T6. The intermediate temperature is lower than the annealing temperature and is matched to the temperature of the melt bath (T7). The intermediate temperature is 600-800° C., preferably at least 660° C., more preferably at least 670° C., more preferably at most 740° C., in particular at most 700° C. For particularly homogeneous interfacial layer formation, it is important that there is adequate thermal energy in the interfacial layer between steel substrate and aluminum melt. This is not the case at temperatures lower than 600° C., such that unwanted compounds can form, the later reconversion of which can lead to pores. Over and above the preferred intermediate temperatures, there is another significant increase in the diffusion rate of iron into aluminum, such that more iron can diffuse into the still-liquid interfacial layer even at the start of the coating process. The duration of the cooling of the annealed flat steel product from the annealing temperature T5 to the intermediate temperature T6 is preferably 10-180 s. In particular, the intermediate temperature T6 differs from the temperature of the melt bath T7 by not more than 30 K, especially not more than 20 K, preferably not more than 10 K.

The flat steel product is subjected to a coating treatment in step k). The coating treatment is preferably effected by continuous hot dip coating. The coating can be applied only on one side, on both sides or on all sides of the flat steel product. The coating treatment is preferably effected as a hot dip coating process, especially as a continuous process. The flat steel product typically comes into contact with the melt bath on all sides, such that it is coated on all sides. The melt bath containing the alloy to be applied to the flat steel product in liquid form is typically at a temperature (T7) of 660-800° C., preferably 680-740° C. Aluminum-based alloys have been found to be particularly suitable for coating of aging-resistant flat steel products with an anticorrosion coating. In such a case, the melt bath contains 0.1-15% by weight of Si, preferably more than 1.0%, optionally 2-4% by weight of Fe, optionally up to 5% by weight of alkali metals or alkaline earth metals, preferably up to 1.0% by weight of alkali metals or alkaline earth metals, and optionally up to 15% Zn, and optional further constituents, the contents of which are limited to a total of not more than 2.0% by weight, and aluminum as the balance. In a preferred variant, the Si content of the melt is 1.0-3.5% by weight or 7-12% by weight, especially 8-10% by weight. In a preferred variant, the optional content of alkali metals or alkaline earth metals in the melt comprises 0.1-1.0% by weight of Mg, especially 0.1-0.7% by weight of Mg, preferably 0.1-0.5% by weight of Mg. In addition, the optional content of alkali metals or alkaline earth metals in the melt may especially comprise at least 0.0015% by weight of Ca, especially at least 0.01% by weight of Ca. Further variants of the melt have been elucidated above in connection with the flat steel product.

After the coating treatment, the coated flat steel product is cooled down to room temperature in step l). A first cooling period t_{MT} in the temperature range between 600° C. and 450° C. (moderate temperature range MT) is more than 10 s, especially more than 14 s, and a second cooling period t_{LT} in the temperature range between 400° C. and 300° C. (low temperature range LT) is more than 8 s, especially more than 12 s.

The first cooling period t_{MT} in the temperature range between 600° C. and 450° C. (moderate temperature range MT) may be achieved by gradual, continuous cooling or else by holding at a temperature for a certain time within this temperature range. Intermediate heating is even possible. All that is important is that the flat steel product remains within the temperature range between 600° C. and 450° C. at least for a period of time of cooling period t_{MT}. Within this temperature range, there is on the one hand a significant diffusion rate of iron into aluminum, and on the other hand the diffusion of aluminum into steel is inhibited since the temperature is below half the melting temperature of steel. This enables diffusion of iron into the anticorrosion coating without significant diffusion of aluminum into the steel substrate.

The diffusion of iron into the anticorrosion coating has several advantages.

Firstly, the melting of the anticorrosion coating is delayed on austenitization prior to press hardening. Secondly, there is homogenization of the coefficients of thermal expansion of anticorrosion coating and substrate. This means that the transition region between the coefficients of thermal expansion of substrate and surface becomes broader, which reduces thermal stresses on reheating.

At the same time, the diffusion of aluminum into the steel substrate would have considerable disadvantages. By virtue of the very high affinity of aluminum for nitrogen, a high aluminum content can have the effect that nitrogen is removed from fine precipitates, such as niobium carbonitrides or titanium carbonitrides, and there is instead preferential formation of coarse precipitates, such as aluminum nitrides, at the grain boundaries. This would worsen crash performance, and also reduce the bending angle. Moreover, this destabilizes the fine precipitates (for example the niobium-containing precipitates) in the uppermost substrate region, which are important in accordance with the invention for reduction of the free hydrogen level. In addition, the inhomogeneous diffusion rate of aluminum in the steel substrate into ferrite compared to pearlite/bainite/martensite would lead to an inhomogeneous distribution of Al in the edge layer of the steel substrate. This should likewise be avoided in order to improve crash performance and bending performance. These disadvantages of the diffusion of aluminum into the steel substrate are therefore reduced or avoided by inhibition.

By virtue of the preferred first cooling time t_{MT} (more than 14 s), there is an increase in the iron concentration in the interfacial transition layer to such an extent that this further reduces the activity of aluminum in the coating directly at the substrate boundary. This then leads to an even further decrease in aluminum uptake into the substrate on austenitization prior to the press hardening with the associated advantages described above.

The second cooling period tur in the temperature range between 400° C. and 300° C. (low temperature range LT) can likewise be achieved by gradual, continuous cooling or else by holding at a temperature for a certain time within this temperature range. Intermediate heating is even possible. All that is important is that the flat steel product remains within the temperature range between 400° C. and 300° C. at least for a period of time of cooling period t_{LT}.

In the case of the preferred second cooling time t_{LT} of more than 12 s, very fine iron carbides (called transition carbides) are additionally formed, which in turn dissolve very quickly on austenitization and lead to additional austenite seeds and hence to an even finer austenite microstructure and hence also hardening microstructure.

The coated flat steel product can optionally be subjected, in the subsequent step m), to a skin pass rolling operation with a degree of skin pass rolling of up to 2%, in order to improve the surface roughness of the flat steel product.

As an alternative to the described process variant, the flat steel product can also be produced in an uncoated variant. In that case, process steps i)-m) are configured as follows:

In step i), the flat steel product is subjected to an annealing treatment at annealing temperatures (T5) of 650-900° C. For this purpose, the flat steel product is first heated to the annealing temperature within 10 to 120 s and then kept at the annealing temperature for 30 to 600 s. The annealing temperature is at least 650° C., preferably at least 720° C. Annealing temperatures above 900° C. are not desirable, for economic reasons.

In step j), the flat steel product is cooled to an intermediate temperature (T6) after annealing. The duration of the cooling of the annealed flat steel product from the annealing temperature T5 to the intermediate temperature T6 is preferably 10-180 s.

Step k) is not implemented in this uncoated variant.

The flat steel product is then cooled to room temperature in step l). A first cooling period t_{MT} in the temperature range between 600° C. and 450° C. (moderate temperature range MT) is more than 10 s, especially more than 14 s, and a second cooling period tur in the temperature range between 400° C. and 300° C. (low temperature range LT) is more than 8 s, especially more than 12 s.

The first cooling period t_{MT} in the temperature range between 600° C. and 450° C. (moderate temperature range MT) may be achieved by gradual, continuous cooling or else by holding at a temperature for a certain time within this temperature range. Intermediate heating is even possible. All that is important is that the flat steel product remains within the temperature range between 600° C. and 450° C. at least for a period of time of cooling period t_{MT}.

The second cooling period t_{LT} in the temperature range between 400° C. and 300° C. (low temperature range LT) can likewise be achieved by gradual, continuous cooling or else by holding at a temperature for a certain time within this temperature range. Intermediate heating is even possible. All that is important is that the flat steel product remains within the temperature range between 400° C. and 300° C. at least for a period of time of cooling period t_{LT}.

In the case of the preferred second cooling time t_{LT} of more than 12 s, very fine iron carbides (called transition carbides) are additionally formed, which in turn dissolve very quickly on austenitization and lead to additional austenite seeds and hence to an even finer austenite microstructure and hence also hardening microstructure.

The uncoated flat steel product thus obtained can optionally be subjected, in the subsequent step m), to a skin pass rolling operation with a degree of skin pass rolling of up to 2%, in order to improve the surface roughness of the flat steel product.

The invention further relates to a shaped sheet metal part formed from a flat steel product comprising an above-elucidated steel substrate and optionally an anticorrosion coating. The anticorrosion coating has the advantage of preventing scale formation during austenitization in the hot forming operation. In addition, such an anticorrosion coating protects the formed shaped sheet metal part against corrosion.

For the shaped sheet metal part, as is the case for the flat steel product, a degree of dispersion D₁ of precipitates in the near-surface third of the steel substrate is subject to the following condition:

$$25 \cdot {10}^{- 6} \frac{1}{nm} < {D}_{2} < 5 \cdot {10}^{- 3} \frac{1}{nm} .$$

In the forming processes described below, the temperatures and holding times are not high enough to bring about any significant change in the precipitates. Consequently, this property of the flat steel product established in the hot rolling operation is passed on to the formed shaped sheet metal part. The precipitates can thus assume the desired function in the formed shaped sheet metal part and reduce the free hydrogen level therein.

In a specific embodiment, the shaped sheet metal part preferably comprises an aluminum-based anticorrosion coating. The anticorrosion coating of the shaped sheet metal part preferably comprises an alloy layer and an Al base layer. In the shaped sheet metal part, the alloy layer is also frequently referred to as interdiffusion layer.

The thickness of the anticorrosion coating is preferably at least 10 μm, more preferably at least 20 μm, especially at least 30 μm.

The thickness of the alloy layer is preferably less than 30 μm, more preferably less than 20 μm, especially less than 16 μm, more preferably less than 12 μm. The thickness of the Al base layer is found from the difference in the thicknesses of anticorrosion coating and alloy layer.

The alloy layer here lies atop and directly adjoins the steel substrate. The alloy layer of the shaped sheet metal part preferably consists of 35-90% by weight of Fe, 0.1-12% by weight of Si, and optional further constituents, the contents of which are limited to a total of not more than 3.5% by weight, preferably 2.0% by weight, and aluminum as the balance. The optional further constituents are preferably the elements present in addition to iron in the steel of the steel substrate and the other elements from the melt such as Zn and alkali metals or alkaline earth metals. These elements from the melt accumulate only to a very small extent in the alloy layer.

The alloy layer preferably has a ferritic microstructure in the near-substrate region.

The Al base layer of the shaped sheet metal part lies atop and directly adjoins the alloy layer. Preferably, the Al base layer of the shaped sheet metal part consists of 35-55% by weight of Fe, 0.4-10% by weight of Si, optionally up to 3% by weight of alkali metals or alkaline earth metals, preferably up to 1.0% by weight of alkali metals or alkaline earth metals, optionally up to 10% of Zn, and optional further constituents, the contents of which are limited to a total of not more than 2.0% by weight, and aluminum as the balance. Preferably, the optional content of alkali metals or alkaline earth metals is at least 0.1% by weight.

In a preferred variant of the Al base layer, the optional content of alkali metals or alkaline earth metals comprises 0.1-1.0% by weight of Mg, especially 0.1-0.7% by weight of Mg, preferably 0.1-0.5% by weight of Mg. In addition, the optional content of alkali metals or alkaline earth metals in the Al base layer may especially comprise at least 0.0015% by weight of Ca, especially at least 0.1% by weight of Ca. Further preferably, the optional content of alkali metals or alkaline earth metals consists of 0.1-1.0% by weight of Mg, especially 0.1-0.7% by weight of Mg, preferably 0.1- 0.5% by weight of Mg, and optionally at least 0.0015% by weight of Ca, especially at least 0.1% by weight of Ca.

The Al base layer may have a homogeneous element distribution in which the local element contents vary by not more than 10%. Preferred variants of the Al base layer, by contrast, have low-silicon phases and silicon-rich phases. Low-silicon phases here are regions wherein the average Si content is at least 20% less than the average Si content of the Al base layer. Silicon-rich phases here are regions wherein the average Si content is at least 20% more than the average Si content of the Al base layer.

In a preferred variant, the silicon-rich phases are disposed within the low-silicon phase. In particular, the silicon-rich phases form at least a 40% continuous layer bounded by low-silicon regions. In an alternative variant embodiment, the silicon-rich phases are arranged in island form in the low-silicon phase.

What is meant by “in insular form” in the context of this application is an arrangement in which discrete noncoherent regions are surrounded by another material—i.e. there are “islands” of a particular material in another material.

In a preferred variant, the shaped sheet metal part comprises an oxide layer disposed atop the anticorrosion coating. The oxide layer lies in particular atop the Al base layer and preferably forms the outer conclusion of the anticorrosion coating.

The oxide layer of the shaped sheet metal part consists especially to an extent of more than 80% by weight of oxides, where the majority of the oxides (i.e. more than 50% by weight of the oxides) is aluminum oxide. The oxide layer optionally includes, in addition to aluminum oxide, hydroxides and/or magnesium oxide alone or as a mixture. The remainder of the oxide layer not accounted for by the oxides and optionally present hydroxides preferably consists of silicon, aluminum, iron and/or magnesium in metallic form.

The oxide layer preferably has a thickness of at least 50 nm, especially of at least 100 nm. In addition, the thickness is not more than 4 μm, especially not more than 2 μm.

In a specific configuration, the shaped sheet metal part comprises a zinc-based anticorrosion coating.

Such a zinc-based anticorrosion coating preferably comprises up to 80% by weight of Fe, 0.2-6.0% by weight of Al, 0.1-10.0% by weight of Mg, optionally 0.1-40% by weight of manganese or copper, optionally 0.1-10.0% by weight of cerium, optionally not more than 0.2% by weight of further elements, unavoidable impurities, and zinc as the balance. In particular, the Al content is not more than 2.0% by weight, preferably not more than 1.5% by weight. The Fe content that arises from inward diffusion is more than 20% by weight, especially more than 30% by weight. In addition, the Fe content is especially not more than 70% by weight, especially not more than 60% by weight. The Mg content is especially not more than 3.0% by weight, preferably not more than 1.0% by weight. The anticorrosion coating may be applied by hot dip coating or by physical gas phase deposition or by electrolytic methods.

In a specific development, the steel substrate of the shaped sheet metal part has a microstructure having at least partly more than 80% martensite, preferably at least partly more than 90% martensite, especially at least partly more than 95%, more preferably at least partly more than 98%. What is meant in this context by “partly having” is that there are regions of the shaped sheet metal part that have the microstructure mentioned. In addition, there may also be regions of the shaped sheet metal part that have a different microstructure. The shaped sheet metal part thus has the microstructure mentioned in sections or regions.

As a result of the high martensite content, it is possible to achieve very high tensile strengths and yield points.

In an alternative development, the steel substrate of the shaped sheet metal part has a microstructure having a ferrite content of more than 5%, preferably more than 10%, in particular more than 20%. In addition, the ferrite content is preferably less than 85%, in particular less than 70%. The martensite content is less than 80%, in particular less than 50%. In addition, the microstructure may optionally contain bainite and/or pearlite. The exact ratio of the microstructure constituents depends on the level of the C content and the Mn content, and also on the cooling conditions in the forming operation. The microstructure thus configured has higher ductility and therefore leads to improved forming characteristics. For instance, a corresponding shaped sheet metal part preferably has an elongation at break A30 within a range from 8% to 25%, preferably between 10% and 22%, in particular between 12% and 20%.

In a further-developed variant, the shaped sheet metal part at least partly has a tensile strength of at least 1500 MPa, in particular at least 1750 MPa, preferably at least 1850 MPa.

In particular, the shaped sheet metal part at least partly has an elongation at break A80 of at least 4%, preferably at least 5%, more preferably at least 6%.

In addition, the shaped sheet metal part, in a preferred variant, may at least partly have a bending angle of at least 30°, especially at least 35°, preferably at least 40°. The bending angle here means the bending angle corrected by the sheet thickness. The corrected bending angle is found from the calculated bending angle at force maximum (measured by VDA standard 238-100) (also referred to as maximum bending angle) from the formula

$$bending {angle}_{corrected} = bending {angle}_{found} \cdot \sqrt{sheet thickness}$$

where sheet thickness in mm should be inserted into the formula. This applies to sheet thicknesses greater than 1.0 mm. For sheet thicknesses less than 1.0 mm, the corrected bending angle corresponds to the determined bending angle.

What is meant in this context by “partly having” is that there are regions of the shaped sheet metal part that have the mechanical property mentioned. In addition, there may also be regions of the shaped sheet metal part where the mechanical property is below the limit. The shaped sheet metal part thus has the mechanical property mentioned in sections or regions. This is because different regions of the shaped sheet metal part can undergo different heat treatments.

For example, individual regions can be cooled more quickly than others, as a result of which more martensite, for example, is formed in the more rapidly cooled regions. Therefore, different mechanical properties are also established in the different regions.

The mechanical indices mentioned have been found to be particularly advantageous in order to assure use in an automobile with good crash performance.

In a particularly preferred variant, the shaped sheet metal part has an aluminum-based anticorrosion coating comprising an alloy layer and an Al base layer. A degree of dispersion D₂ of precipitates in the alloy layer is subject to the following condition:

$$25 \cdot {10}^{- 6} \frac{1}{nm} < {D}_{2} < 5 \cdot {10}^{- 3} \frac{1}{nm}$$

As a result of the adjustment of the precipitates in the steel substrate of the flat steel product, there is likewise a corresponding degree of dispersion D₂ in the preferably ferritic alloy layer. This is particularly advantageous since hydrogen that enters as a result can already be trapped in the soft alloy layer before it enters the steel substrate. This reduces the risk of hydrogen embrittlement even further, since the hydrogen cannot penetrate the hard substrate which is therefore susceptible to embrittlement.

The shaped sheet metal part of the invention is preferably a component for a land vehicle, nautical vessel or aircraft. It is more preferably an automobile component, especially a bodywork component. The component is preferably a B pillar, longitudinal beam, A pillar, sill or transverse beam.

In the process of the invention for production of an inventive shaped sheet metal part of the type as elucidated above, at least the following steps are performed:
a) providing a sheet metal blank from a flat steel product as described above;
b) heating the sheet metal blank such that the AC3 temperature of the blank is exceeded at least in parts and the temperature Tᵢₙₛ of the blank on insertion into a forming tool provided for a hot press forming operation (step c)) is at least partly at a temperature above Ms+100° C. where Ms denotes the martensite start temperature;
c) inserting the heated sheet metal blank into a forming tool, where the transfer period tₜᵣₐₙₛ required for the removal from the heating device and the insertion of the blank is not more than 20 s, preferably not more than 15 s;
d) hot press forming the sheet metal blank to the shaped sheet metal part, where the blank in the course of hot press forming is cooled to the target temperature T_{target} over a period tₜₒₒₗ of more than 1 s at a cooling rate rₜₒₒₗ of at least partly more than 30 K/s and optionally held at that temperature;
e) removing the shaped sheet metal part that has been cooled to the target temperature T_{target} from the tool.

In the process of the invention, a blank consisting of a steel of suitable composition in accordance with the elucidations above is thus provided (step a)) and is then heated in a manner known per se such that the AC3 temperature of the blank is exceeded at least in part and the temperature Tᵢₙₛ of the blank on insertion into a forming tool provided for a hot press forming operation (step c)) is at least partly at a temperature above Ms+100° C. What is meant in the context of this application by “exceedance of a temperature in part” (here, AC3 or Ms+100° C.) is that at least 30%, especially at least 60%, of the volume of the blank exceeds a corresponding temperature. On insertion into the forming tool, at least 30% of the blank thus has an austenitic microstructure, meaning that the transformation from the ferritic to austenitic microstructure need not be complete on insertion into the forming tool. Instead, up to 70% of the volume of the blank on insertion into the forming tool may consist of other microstructure constituents, such as annealed bainite, annealed martensite and/or non-recrystallized or partly recrystallized ferrite. For this purpose, particular regions of the blank may be specifically kept at a lower temperature level during the heating than others. For this purpose, the supply of heat may be directed specifically only to particular sections of the blank, or the parts that are to be heated to a lesser degree may be shielded against the supply of heat. In the part of the blank material wherein the temperature remains lower, only a distinctly smaller amount of martensite, if any, is formed in the course of forming in the tool, such that the microstructure there is much softer than in the respective other parts in which there is a martensitic microstructure. In this way, in the respectively formed shaped sheet metal part, it is possible to specifically establish a softer region in which, for example, toughness is optimal for the respective end use, while the other regions of the shaped sheet metal part have maximized strength.

Maximum strength properties of the resultant shaped sheet metal part may be enabled in that the temperature attained at least in parts in the sheet metal blank is between Ac3 and 1000° C., preferably between 850° C. and 950° C.

The minimum temperature Ac3 to be exceeded is determined by the following formula specified by HOUGARDY, H P. in Werkstoffkunde Stahl, Band 1: Grundlagen [Materials; Steel; Volume 1: Principles], Verlag Stahleisen GmbH, Düsseldorf, 1984, p. 229:

$$Ac 3 = ( 902 - {255}^{*} \% C + {19}^{*} \% Si - {11}^{*} \% Mn - {5}^{*} \% Cr + {13}^{*} \% Mo - {20}^{*} \% Ni + {55}^{*} \% V ) ° C .$$

with % C=respective C content, % Si=respective Si content, % Mn=respective Mn content, % Cr=respective Cr content, % Mo=respective Mo content, % Ni=respective Ni content and % V=respective V content of the steel of which the blank consists.

An optimally uniform distribution of properties can be achieved in that the blank is fully through-heated in step b).

In a preferred variant embodiment, the average heating rate r_{furnace} of the sheet metal blank on heating in step b) is at least 3 K/s, preferably at least 5 K/s, especially at least 10 K/s, preferably at least 15 K/s. The average heating rate r_{furnace} here means the average heating rate from 30° C. to 700° C.

In a preferred execution variant, the heating is effected in a furnace having a furnace temperature T_{furnace} of at least 850° C., preferably at least 880° C., more preferably at least 900° C., especially at least 920° C., and not more than 1000° C., preferably not more than 950° C., more preferably not more than 930° C.

Preferably, the dewpoint of the furnace atmosphere in the furnace here is at least −20° C., preferably at least −15° C., especially at least −5° C., more preferably at least 0° C., and not more than +25° C., preferably not more than +20° C., especially not more than +15° C.

In a specific execution variant, the heating in step b) is effected stepwise in regions with different temperature. In particular, the heating is effected in a roller hearth furnace with different heating zones. The heating is effected here in a first heating zone with a temperature (called the furnace entry temperature) of at least 650° C., preferably at least 680° C., especially at least 720° C. The temperature in the first heating zone is preferably not more than 900° C., especially not more than 850° C. Further preferably, the maximum temperature of all heating zones in the furnace is not more than 1200° C., especially not more than 1000° C., preferably not more than 950° C., more preferably not more than 930° C.

The total time in the furnace t_{furnace}, composed of a heating time and a hold time, in both variants (constant furnace temperature, stepwise heating), is preferably at least 2 minutes, especially at least 3 minutes, preferably at least 4 minutes. In addition, the total time in the furnace in both variants is preferably not more than 20 minutes, especially not more than 15 minutes, preferably not more than 12 minutes, especially not more than 8 minutes. Prolonged total times in the furnace have the advantage that uniform austenitization of the sheet metal blank is assured. On the other hand, holding above Ac3 for an excessively long period leads to grain coarsening, which has an adverse effect on mechanical properties.

The blank which has thus been heated is removed from the respective heating device, which may, for example, be a conventional heating furnace, an induction heating device which is likewise known per se, or a conventional device for keeping shaped sheet metal parts hot, and transported into the forming tool with sufficient speed that its temperature on arrival in the tool is at least partly above Ms+100° C., preferably above 600° C., especially above 650° C., more preferably above 700° C. Ms here denotes the martensite start temperature. In a particularly preferred variant, the temperature is at least partly above the AC1 temperature. In all these variants, the temperature is especially not more than 900° C. These temperature ranges assure good formability of the material overall.

In step c), the transfer of the austenitized blank from the respectively used heating device to the forming tool is performed within preferably not more than 20 s, especially not more than 15 s. Such rapid transport is required in order to avoid excessive cooling prior to shaping.

The tool on insertion of the blank is typically at a temperature between room temperature (RT) and 200° C., preferably between 20° C. and 180° C., especially between 50° C. and 150° C. In a particular embodiment, the tool may be adjusted at least in regions to a temperature Tₜₒₒₗ of at least 200° C., especially at least 300° C., in order to only partially harden the component. In addition, the tool temperature Tₜₒₒₗ is preferably not more than 600° C., especially not more than 550° C. It merely has to be ensured that the tool temperature Tₜₒₒₗ is below the desired target temperature T_{target}. The dwell time in the tool tₜₒₒₗ is preferably at least 2 s, especially at least 3 s, more preferably at least 5 s. The dwell time in the tool is preferably not more than 25 s, especially not more than 20 s.

The target temperature T_{target} of the shaped sheet metal part is at least partly below 400° C., preferably below 300° C., especially below 250° C., preferably below 200° C., more preferably below 180° C., especially below 150° C. Alternatively, the target temperature T_{target} of the shaped sheet metal part is more preferably below Ms−50° C., where Ms denotes the martensite start temperature. In addition, the target temperature of the shaped sheet metal part is preferably at least 20° C., more preferably at least 50° C.

The martensite start temperature of a steel within the provisions of the invention should be calculated by the formula

$$Ms [ ° C . ] = ( 490.85 - 302.6 \% C - 30.6 \% Mn - 16.6 \% Ni - 8.9 \% Cr + 2.4 \% Mo - - 11.3 \% Cu + 8.58 \% Co + 7.4 \% W - 14.5 \% Si ) [ ° C . / \% by weight ]$$

where C % here denotes the C content, % Mn the Mn content, % Mo the Mo content, % Cr the Cr content, % Ni the Ni content, % Cu the Cu content, % Co the Co content, % W the W content and % Si the Si content of the respective steel in % by weight.

The AC1 temperature and the AC3 temperature of a steel within the provisions of the invention should be calculated by the formulae:

$$A C 1 [ ° C . ] = ( 739 - {22}^{*} \% C - {7}^{*} \% Mn + {2}^{*} \% Si + 1 {4}^{*} \% Cr + {13}^{*} \% Mo - 1 {3}^{*} \% Ni + {20}^{*} \% V ) [ ° C . / \% by weight ]$$

$$and$$

$$A C 3 [ ° C . ] = ( 902 - {225}^{*} \% C + {19}^{*} \% Si - {11}^{*} \% Mn - {5}^{*} \% Cr + {13}^{*} \% Mo - {20}^{*} \% Ni + {55}^{*} \% V ) [ ° C . / \% by weight ]$$

where, here too, % C denotes the C content, % Si the Si content, % Mn the Mn content, % Cr the Cr content, % Mo the Mo content, % Ni the Ni content and +% V the vanadium content of the respective steel (Brandis H 1975 TEW-Techn. Ber. 1 8-10).

In the tool, the blank is thus not just shaped to give the shaped sheet metal part, but simultaneously also quenched to the target temperature. The cooling rate in the tool rₜₒₒₗ to the target temperature is especially at least 20 K/s, preferably at least 30 K/s, especially at least 50 K/s, in a particular execution at least 100 K/s.

The removal of the shaped sheet metal part in step e) is followed by cooling of the shaped sheet metal part to a cooling temperature T_{cool} of less than 100° C. within a cooling period t_{cool} of 0.5 to 600 s. This is generally accomplished by air cooling.

The invention is elucidated in detail by working examples.

The effect of the invention was demonstrated by conducting a number of experiments. For this purpose, slabs having the compositions specified in table 1 were produced with a thickness of 200-280 mm and width of 1000-1200 mm, heated up to a respective temperature T1 in a pusher furnace and kept at T1 for between 30 and 450 min until the temperature T1 had been attained in the core of the slabs and hence the slabs were through-heated. The production parameters are reported in table 2. The slabs with their respective through-heating temperature T1 were discharged from the blast furnace and subjected to hot rolling. The experiments were performed in the form of a continuous hot strip rolling operation. For this purpose, the slabs were first prerolled to an intermediate product of thickness 40 mm, and the intermediate products, which can also be referred to as preliminary strips in the hot strip rolling operation. The preliminary strips were fed to the finish rolling immediately after prerolling, with the preliminary strip temperature T2 corresponding to the temperature at the beginning of the strip in the hot rolling operation. In all cases except for experiment 11, the local temperature of the preliminary strip was adjusted such that the temperatures of the individual sections of the preliminary strip do not vary by more than 60 K in the hot rolling operation. Table 2, with ΔT2, indicates the differential between maximum and minimum temperature of the individual sections of the preliminary strip, in each case on entry of the corresponding sections into the rolling mill. In experiment 11, no such temperature control measure was used, whereupon the temperature along the strip dropped with a temperature variation of 122 K. In all other cases, suitable temperature control measures were used, and so the temperature variation is not more than 43 K. Specifically, the preliminary strips were guided through an enclosed area, which reduced cooling. The preliminary strips were rolled out to hot strips having a final thickness of 3-7 mm and the respective final rolling temperatures T3 specified in table 2, cooled down to the coiling temperature T4 and wound up to coils at the respective coiling temperatures T4 and then cooled under stationary air. The hot strips were descaled by pickling in a conventional manner, before being subjected to cold rolling with the degrees of cold rolling specified in table 2. The thickness of the steel strips produced was between 1.0 mm and 2.0 mm in all the experiments.

The cold-rolled flat steel products 1-13 were heated in a tunnel annealing furnace to a respective annealing temperature T5 (see table 3) and kept at annealing temperature T5 for 100 s in each case, before being cooled down to their respective intermediate temperature T6 at a cooling rate of 1 K/s. The cold strips with their respective intermediate temperature T6 (or dipping temperature T6) were conducted through a molten coating bath at temperature T7. The composition of the coating bath is reported in table 3. After the coating operation, the coated strips were blown in a conventional manner, producing coats with different layer thicknesses (see table 3). The strips were first cooled down to 600° C. at an average cooling rate of 10-15 K/s. In the course of further cooling between 600° C. and 450° C. and between 400° C. and 300° C., the strips were cooled down over the cooling periods T_{MT} and T_{LT} specified in table 2. Between 450° C. and 400° C. and below 220° C., the strips were cooled down at a cooling rate of 5-15 K/s in each case.

For comparison, flat steel products 1, 5 and 10 were subjected to an appropriate annealing treatment in a tunnel annealing furnace without being coated. These are experiments 14, 15, 16. Therefore, the production conditions of strips 1 and 14, and 5 and 15, and 10 and 16 in table 2 are identical. The cold-rolled flat steel products 14-16 were heated in a tunnel annealing furnace to a respective annealing temperature T5 (see table 3) and kept at annealing temperature T5 for 100 s in each case, before being cooled down to their respective intermediate temperature T6 at a cooling rate of 1 K/s. Then the strips were first cooled down to 600° C. at an average cooling rate of 10-15 K/s. In the course of further cooling between 600° C. and 450° C. and between 400° C. and 300° C., the strips were cooled down over the cooling periods T_{MT} and T_{LT} specified in table 2. Between 450° C. and 400° C. and below 220° C., the strips were cooled down at a cooling rate of 5-15 K/s in each case.

After cooling to room temperature, longitudinal sections of the flat steel products thus produced were created. In the case of longitudinal sections, the section plane is at right angles to the strip surface and parallel to the main direction of deformation (rolling direction). These longitudinal sections showed the whole thickness of the flat steel product (substrate and anticorrosion coating). Carbon extraction replicas were created using these longitudinal sections. For determination of D₁, these carbon extraction replicas were produced in the near-surface third. The carbon extraction replicas were examined by transmission electron microscope (TEM) and evaluated by computer-aided image analysis.

In inventive variants 1-10 and 14-16, the results were all between

$$25 \cdot {10}^{- 6} \frac{1}{nm} and 5 \cdot {10}^{- 3} \frac{1}{nm} .$$

In comparison variant 11, the precipitation process firstly proceeds locally differently because of the large temperature fluctuation in the preliminary strip ΔT2. The result is therefore a heterogeneous dispersion. Secondly, large amounts of precipitate-forming elements likewise lead to a high driving force for formation of precipitates. Moreover, the temperature variation ΔT2 leads to different cooling characteristics of the coiled coil. The result is therefore high dispersion throughout the strip. Both this high dispersion and the inhomogeneity thereof lead collectively to a deterioration in the mechanical properties, in particular the low bending angle, of the final shaped sheet metal part.

In comparison variant 12, the temperature T1 is too low, such that it was not possible to dissolve a sufficient amount of usually coarse precipitates that are already present in the slab. Therefore, the driving force for the formation of precipitates and hence the amount of precipitates is small. In addition, there are still coarse, undissolved precipitates that increase the average diameter of the precipitates. This leads to insufficient dispersion and insufficient binding of hydrogen in the shaped sheet metal part.

In comparison variant 13, the temperature T2 is so high that virtually all the precipitates present in the slab are dissolved. Because of the large amount of precipitate-forming elements (as evidenced, for example, by the value of

$${( Mo \cdot Cr \cdot Ti \cdot V \cdot Nb )}^{\frac{C}{5}} ) ,$$

the driving force for the formation of precipitates is high and therefore a large amount of predominantly fine precipitates are formed and hence there is high dispersion. Although this has a positive effect on the diffusible hydrogen content, which is very low, there is also a deterioration in the mechanical properties of the shaped sheet metal part, which can be seen by the bending angle.

For comparison variants 11-13, the entries not according to the invention are underlined in the tables.

Blanks have been divided from each of the 16 steel steps thus produced, which were used for the further experiments. The data for these are reported in table 4. In these experiments, shaped sheet metal part samples 1-16 in the form of sheets of size 200×300 mm² were hot press formed from the respective blanks. For this purpose, the blanks have been heated in a heating device, for example in a conventional heating furnace, from room temperature at an average heating rate r_{furnace} (between 30° C. and 700° C.) in a furnace with a furnace temperature T_{furnace}. The total duration in the furnace, comprising heating and holding, is designated t_{furnace}. The dewpoint of the furnace atmosphere is reported in table 4. Subsequently, the blanks have been removed from the heating device and inserted into a forming tool at temperature Tₜₒₒₗ. At the time of removal from the furnace, the blanks had assumed the furnace temperature. The transfer time tₜᵣₐₙₛ, composed of the time for removal from the heating device, transport to the tool and insertion into the tool, was 8 s. In all cases, the temperature Tᵢₙₛ of the blanks on insertion into the forming tool was above the respective martensite start temperature+100° C. In the forming tool, the blanks were formed into the respective shaped sheet metal part; the shaped sheet metal parts in the tool were cooled at a cooling rate rₜₒₒₗ. The dwell time in the tool is designated tₜₒₒₗ. Finally, the samples have been cooled to room temperature under air. Table 4 gives the parameters mentioned for various variants, where “RT” is an abbreviation of room temperature.

Table 5 is a compilation of the overall results for the shaped sheet metal parts obtained. The first columns indicate the sample number and steel grade as shown in table 1. The remaining columns indicate the proportion of free hydrogen, bending angle and tensile strength. Methods of determining the proportion of free hydrogen are known as such to the person skilled in the art, for example desorption mass spectrometry with heated samples (thermal desorption mass spectrometry (TDMS)).

For the uncoated samples, the proportion of free hydrogen was below the detection limit. The degree of dispersion D₁ for uncoated samples 14-16 was comparable to the respective coated samples 1, 5 and 10 because of the comparable annealing treatment. The fact that the same inventive distribution of the precipitates is established in the uncoated samples has the result here too that they are effective hydrogen traps. There is thus an improvement in stability to hydrogen embrittlement under corrosion conditions when the shaped sheet metal part is used.

The maximum bending angle has been determined according to VDA standard 238-100 with a bending axis perpendicular to rolling direction. The maximum bending angle is calculated in each case by the formula specified in the standard from the path of the ram (the maximum bending angle is the bending angle at which the force has its maximum in the bending experiment). In order to eliminate the influence of sheet thickness on the bending angle, the corrected bending angle was calculated from the maximum bending angle by the formula

$$bending {angle}_{corrected} = bending {angle}_{max} \cdot \sqrt{sheet thickness}$$

where sheet thickness in mm should be inserted into the formula. Tensile stress was determined on samples transverse to rolling direction in accordance with DIN EN ISO 6892-1, sample shape 2 (Annex B Tab. B1).

After cooling to room temperature, longitudinal sections of the shaped sheet metal parts thus produced were created. In the case of longitudinal sections, the section plane is at right angles to the strip surface and parallel to the main direction of deformation (rolling direction). These longitudinal sections showed the whole thickness of the shaped sheet metal part (substrate and anticorrosion coating). Carbon extraction replicas were created using these longitudinal sections. For determination of D₁, these carbon extraction replicas were produced in the near-surface third. For determination of D₂, the carbon extraction replicas were created in the alloy layer. The carbon extraction replicas were examined by transmission electron microscope (TEM) and evaluated by computer-aided image analysis.

$$25 \cdot {10}^{- 6} \frac{1}{nm} and 5 \cdot {10}^{- 3} \frac{1}{nm}$$

In the case of inventive samples 1-10, the degree of dispersion D₂ was between (see table 5).

The uncoated samples naturally do not have an alloy layer, and so the degree of dispersion D₂ is undefined.

The degree of dispersion D₁ was found to correspond to the degree of dispersion D₁ using the flat steel product prior to forming within the scope of measurement accuracy. The forming process described thus does not result in any significant change in the degree of dispersion D₁. This is probably because the heating is not high enough or does not last for long enough to lead to dissolution of the precipitates. The degree of dispersion D₁ is therefore not repeated in table 5, but corresponds to the values in table 3.

In addition, the microstructure of the shaped sheet metal part was determined in each case. In all cases, a martensitic microstructure with a martensite content of more than 95 area % was found.

TABLE 1
(steel types)

| Steel | C | Mn | Si | Al | Mo | Ni | Cr | Ti | V | Nb |
|---|---|---|---|---|---|---|---|---|---|---|
| A | 0.31 | 1.1 | 0.15 | 0.2 | 0.1 | 0.03 | 0.11 | 0.008 | 0.15 | 0.02 |
| B | 0.326 | 1.4 | 0.266 | 0.041 | 0.006 | 0.013 | 0.265 | 0.042 | 0.202 | 0.003 |
| C | 0.34 | 0.62 | 0.62 | 0.033 | 0.15 | 0.42 | 0.52 | 0.025 | 0.04 | 0.035 |
| D | 0.33 | 0.8 | 0.52 | 0.043 | 0.31 | 0.76 | 0.91 | 0.032 | 0.22 | 0.042 |
| E | 0.37 | 0.66 | 0.63 | 0.024 | 0.22 | 1.12 | 0.65 | 0.008 | 0.12 | 0.028 |
| F | 0.32 | 2.0 | 0.26 | 0.7 | 0.25 | 0.035 | 0.3 | 0.01 | 0.20 | 0.003 |
| G | 0.34 | 1.05 | 0.16 | 0.2 | 0.1 | 0.027 | 0.12 | 0.0092 | 0.04 | 0.025 |
| H | 0.343 | 0.6 | 0.5 | 0.7 | 0.12 | 0.4 | 0.26 | 0.03 | 0.18 | 0.003 |
| 1 | 0.347 | 0.8 | 0.5 | 0.25 | 0.5 | 0.4 | 0.301 | 0.045 | 0.198 | 0.07 |
| J | 0.43 | 0.25 | 0.19 | 0.035 | 0.7 | 0.05 | 0.05 | 0.013 | 0.004 | 0.013 |
| K | 0.32 | 1.4 | 0.26 | 0.7 | 0.25 | 0.035 | 0.3 | 0.01 | 0.20 | 0.06 |
| L | 0.343 | 0.6 | 0.5 | 0.7 | 0.12 | 0.4 | 0.26 | 0.03 | 0.18 | 0.003 |
| M | 0.347 | 0.8 | 0.5 | 0.25 | 0.5 | 0.4 | 0.301 | 0.045 | 0.198 | 0.07 |

| Steel | B | N | P | S | Sb | Co | Ca | ${( Mo \cdot Cr \cdot Ti \cdot V \cdot Nb )}^{\frac{C}{5}}$ | Ni + Cr |
|---|---|---|---|---|---|---|---|---|---|
| A | 0.002 | 0.004 | 0.005 | 0.0005 | 0.005 | 0.1 | 0.0006 | 0.391 | 0.14 |
| B | 0.0019 | 0.0056 | 0.013 | 0.002 | 0.003 | 0.006 | 0.0005 | 0.330 | 0.278 |
| C | 0.0028 | 0.0045 | 0.011 | 0.0015 | 0.001 | 0.007 | 0.001 | 0.418 | 0.94 |
| D | 0.0032 | 0.0043 | 0.01 | 0.002 | 0.0015 | 0.001 | 0.003 | 0.538 | 1.67 |
| E | 0.0021 | 0.0041 | 0.015 | 0.001 | 0.0011 | 0.0042 | 0.0005 | 0.397 | 1.77 |
| F | 0.0035 | 0.0042 | 0.001 | 0.0007 | 0.001 | 0.11 | 0.0007 | 0.392 | 0.335 |
| G | 0.0025 | 0.0045 | 0.005 | 0.0006 | 0.004 | 0.12 | 0.0005 | 0.336 | 0.147 |
| H | 0.0019 | 0.006 | 0.012 | 0.002 | 0.003 | 0.006 | 0.0006 | 0.370 | 0.66 |
| 1 | 0.0018 | 0.0052 | 0.012 | 0.002 | 0.003 | 0.008 | 0.0005 | 0.525 | 0.701 |
| J | 0.0021 | 0.004 | 0.012 | 0.0005 | 0.005 | 0.05 | 0.0008 | 0.221 | 0.1 |
| K | 0.0035 | 0.0042 | 0.001 | 0.0007 | 0.001 | 0.11 | 0.0012 | 0.475 | 0.335 |
| L | 0.0019 | 0.006 | 0.012 | 0.002 | 0.003 | 0.006 | 0.0015 | 0.370 | 0.66 |
| M | 0.0018 | 0.0052 | 0.012 | 0.002 | 0.003 | 0.008 | 0.0025 | 0.525 | 0.701 |

balance: iron and unavoidable impurities figures each in % by weight;

TABLE 2
(production conditions for flat steel product)

| | | | Temperature | | | | | | | |
|---|---|---|---|---|---|---|---|---|---|---|
| Experiment | Steel | T1 | control | T2 | ΔT2 | T3 | | T4 | DCR | Thickness |
| number | grade | [° C.] | measure | [° C.] | [K] | [° C.] | T2/T3 | [° C.] | [%] | [mm] |
| 1 | A | 1280 | yes | 850 | 38 | 842 | 1.01 | 632 | 52 | 1.0 |
| 2 | B | 1285 | yes | 1018 | 25 | 848 | 1.2 | 636 | 53 | 1.5 |
| 3 | C | 1282 | yes | 938 | 37 | 845 | 1.11 | 634 | 52 | 1.48 |
| 4 | D | 1277 | yes | 1042 | 27 | 847 | 1.23 | 637 | 54 | 1.38 |
| 5 | E | 1284 | yes | 1010 | 25 | 856 | 1.18 | 640 | 48 | 1.67 |
| 6 | F | 1279 | yes | 891 | 28 | 849 | 1.05 | 642 | 59 | 1.85 |
| 7 | G | 1290 | yes | 967 | 24 | 879 | 1.1 | 599 | 34 | 2.0 |
| 8 | H | 1280 | yes | 989 | 40 | 860 | 1.15 | 608 | 45 | 1.5 |
| 9 | I | 1275 | yes | 848 | 43 | 785 | 1.08 | 612 | 51 | 1.8 |
| 10 | J | 1295 | yes | 997 | 39 | 890 | 1.12 | 635 | 49 | 1.3 |
| 11 | K | 1280 | no | 853 | 122 | 812 | 1.05 | 608 | 56 | 1.5 |
| 12 | L | 1020 | yes | 774 | 32 | 815 | 0.95 | 616 | 50 | 1.5 |
| 13 | M | 1350 | yes | 1162 | 36 | 830 | 1.4 | 630 | 44 | 1.5 |
| 14 | A | 1280 | yes | 850 | 38 | 842 | 1.01 | 632 | 52 | 1.0 |
| 15 | E | 1284 | yes | 1010 | 25 | 856 | 1.18 | 640 | 48 | 1.67 |
| 16 | J | 1295 | yes | 997 | 39 | 890 | 1.12 | 635 | 49 | 1.3 |

TABLE 3
(production conditions for coating)

| | | | | | | | | | Slice | | | |
|---|---|---|---|---|---|---|---|---|---|---|---|---|
| | | | | | Melt analysis ([% by | | | | thickness | | | |
| | | | | | wt.], balance in each | | | | (single- | | | Degree of |
| Experiment | Steel | T5 | T6 | T7 | case Al) | | | | sided) | t_{MT} | t_{LT} | dispersion |
| number | grade | [° C.] | [° C.] | [° C.] | Si | Fe | Mg | Others | [μm] | [s] | [s] | D₁ |
| 1 | A | 737 | 717 | 712 | 8.5 | 3.5 | 0.35 | <1 | 23 | 24 | 28 | 4.5 × 10^{Λ} − 4 |
| 2 | B | 871 | 713 | 700 | 8.5 | 3.6 | 0.2 | <1 | 27 | 18 | 19 | 6.8 × 10^{Λ} − 4 |
| 3 | C | 721 | 676 | 674 | 8.8 | 3.4 | 0.22 | <1 | 19 | 20 | 21 | 5.3 × 10^{Λ} − 4 |
| 4 | D | 850 | 795 | 783 | 8.6 | 3.2 | 0.45 | <1 | 23 | 15 | 17 | 5.0 × 10^{Λ} − 4 |
| 5 | E | 834 | 800 | 787 | 9.2 | 3.8 | 0.36 | <1 | 24 | 14 | 17 | 3.3 × 10^{Λ} − 3 |
| 6 | F | 812 | 775 | 771 | 9 | 2.8 | 0.5 | <1 | 20 | 22 | 23 | 3.0 × 10^{Λ} − 4 |
| 7 | G | 845 | 784 | 779 | 9.5 | 2.9 | 0 | <1 | 23 | 25 | 28 | 8.7 × 10^{Λ} − 4 |
| 8 | H | 746 | 717 | 714 | 8 | 3.3 | 0 | <1 | 23 | 16 | 21 | 2.8 × 10^{Λ} − 4 |
| 9 | I | 757 | 706 | 697 | 8.2 | 3.5 | 0.3 | <1 | 25 | 18 | 19 | 3.5 × 10^{Λ} − 5 |
| 10 | J | 823 | 788 | 781 | 9.1 | 3.6 | 0.31 | <1 | 28 | 23 | 27 | 1.2 × 10^{Λ} − 3 |
| 11 | K | 890 | 785 | 782 | 8.6 | 2.9 | 0 | <1 | 25 | 16 | 21 | 5.5 × 10^{Λ} − 3 |
| 12 | L | 770 | 736 | 732 | 8.5 | 3 | 0.23 | <1 | 23 | 22 | 24 | 2.4 × 10^{Λ} − 6 |
| 13 | M | 732 | 679 | 664 | 9 | 3.2 | 0.3 | <1 | 24 | 19 | 19 | 9.8 × 10^{Λ} − 3 |
| 14 | A | 735 | 720 | | | | | | | 24 | 27 | 5.3 × 10^{Λ} − 4 |
| 15 | E | 817 | 780 | | | | | | | 15 | 19 | 3.7 × 10^{Λ} − 3 |
| 16 | J | 829 | 795 | | | | | | | 21 | 25 | 1.4 × 10^{Λ} − 3 |

TABLE 4
(hot forming parameters)

| | Average | | | | | | | | | |
|---|---|---|---|---|---|---|---|---|---|---|
| | heating | | | | | | | | Cooling | |
| | rate r_{furnace} | | | | Transfer | | | | rate | |
| Experiment | [30-700° | T_{furnace} | t_{furnace} | Dewpoint | time | Tᵢₙₛ | Tₜₒₒₗ | tₜₒₒₗ | rₜₒₒₗ | T_{target} |
| number | C.] [K/s] | [° C.] | [s] | [° C.] | [s] | [° C.] | [° C.] | [s] | [K/s] | [° C.] |
| 1 | 8 | 880 | 260 | 5 | 8 | 720 | RT | 15 | 50 | 50 |
| 2 | 8 | 930 | 360 | 10 | 8 | 790 | RT | 15 | 50 | 50 |
| 3 | 8 | 925 | 300 | −5 | 8 | 790 | RT | 15 | 50 | 50 |
| 4 | 8 | 910 | 300 | −15 | 8 | 770 | RT | 15 | 50 | 50 |
| 5 | 8 | 855 | 360 | 16 | 8 | 740 | RT | 15 | 50 | 50 |
| 6 | 8 | 950 | 360 | 15 | 8 | 825 | RT | 15 | 50 | 50 |
| 7 | 8 | 920 | 420 | 8 | 8 | 810 | RT | 15 | 50 | 50 |
| 8 | 8 | 890 | 320 | 7 | 8 | 760 | RT | 15 | 50 | 50 |
| 9 | 8 | 930 | 500 | 3 | 8 | 810 | RT | 15 | 50 | 50 |
| 10 | 8 | 950 | 600 | 5 | 8 | 800 | RT | 15 | 50 | 50 |
| 11 | 8 | 920 | 360 | 7 | 8 | 780 | RT | 15 | 50 | 50 |
| 12 | 8 | 950 | 360 | 7 | 8 | 810 | RT | 15 | 50 | 50 |
| 13 | 8 | 890 | 360 | 7 | 8 | 760 | RT | 15 | 50 | 50 |
| 14 | 8 | 880 | 260 | 5 | 8 | 720 | RT | 15 | 50 | 50 |
| 15 | 8 | 855 | 360 | 16 | 8 | 740 | RT | 15 | 50 | 50 |
| 16 | 8 | 950 | 600 | 5 | 8 | 800 | RT | 15 | 50 | 50 |

TABLE 5
(shaped sheet metal part)

| | | | | Tensile | Degree of |
|---|---|---|---|---|---|
| Experiment | Steel | H_{diff} | Bending angle | strength | dispersion |
| number | grade | [ppm] | [°] | [MPa] | D₂ |
| 1 | A | 0.08 | 42 | 1870 | 6.6 × 10\hat{ } − 4 |
| 2 | B | 0.1 | 35 | 1750 | 9.0 × 10\hat{ } − 4 |
| 3 | C | 0.08 | 44 | 1810 | 1.0 × 10\hat{ } − 3 |
| 4 | D | 0.05 | 43 | 1870 | 8.1 × 10\hat{ } − 4 |
| 5 | E | 0.16 | 35 | 1890 | 3.9 × 10\hat{ } − 3 |
| 6 | F | 0.07 | 35 | 1980 | 5.2 × 10\hat{ } − 4 |
| 7 | G | 0.19 | 41 | 1920 | 1.3 × 10\hat{ } − 3 |
| 8 | H | 0.17 | 39 | 1880 | 3.8 × 10\hat{ } − 4 |
| 9 | I | 0.05 | 41 | 1850 | 6.7 × 10\hat{ } − 5 |
| 10 | J | 0.05 | 33 | 1950 | 1.8 × 10\hat{ } − 3 |
| 11 | K | 0.18 | 25 | 1910 | 5.8*10\hat{ } − 3 |
| 12 | L | 0.32 | 32 | 1870 | 3.5*10\hat{ } − 6 |
| 13 | M | 0.09 | 23 | 1900 | 1.3*10\hat{ } − 2 |
| 14 | A | | 39 | 1880 | |
| 15 | E | | 36 | 1870 | |
| 16 | J | | 34 | 1930 | |

1-18. (canceled)

19. A flat steel product for hot forming, comprising a steel substrate composed of comprising iron and in % by weight:
C: 0.25-0.8%,
Si: 0.01-2.0%,
Al: 0.001-1.0%,
B: 0.0005-0.01%,
P: ≤0.03%,
S: ≤0.02%,
N: ≤0.03%,
Sn: ≤0.03%,
As: ≤0.01%,
Sb: ≤0.02%, and
unavoidable impurities, and
at least one of the elements in the group comprising Ti, Nb and V, with the proviso that the contents are as follows:
Ti: 0.008-0.10%,
Nb: 0.01-0.07%, and
V: 0.01-0.4%,
where a degree of dispersion D₁ of precipitates in the near-surface third of the steel substrate is subject to the following condition:
$$25 \cdot {10}^{- 6} \frac{1}{nm} < {D}_{1} < 5 \cdot {10}^{- 3} \frac{1}{nm} .$$

20. The flat steel product as claimed in claim 19, wherein the steel further comprises one or more of elements “Cr, Mn, Co, Cu, Mo, Ni, Ca, W, Ce, La” in the following contents:
Cr: 0.01-1.0%,
Mn: 0.01-3.5%,
Co: 0.05-1.0%,
Cu: 0.01-0.2%,
Mo: 0.002-1.0%,
Ni: 0.01-2.0%,
Ca 0.0005-0.01%,
W: 0.001-1.0%, and
Ce+La: 0.01-0.03%.

21. The flat steel product as claimed in claim 20, wherein the elements Mo, Cr, Ti, V and Nb are present in the steel and wherein the element contents are subject to the following condition:
$$0.03 < {( Mo \cdot Cr \cdot Ti \cdot V \cdot Nb )}^{\frac{C}{5}} < 0.4$$

22. The flat steel product as claimed in claim 20, wherein the element contents are subject to the following condition:
$$N i + C r \leq 1.1$$

23. The flat steel product as claimed in claim 19 comprises an anticorrosion coating on at least one side.

24. The flat steel product as claimed in claim 23, characterized in that the anticorrosion coating is an aluminum-based anticorrosion coating and has an alloy layer and an Al base layer.

25. The flat steel product as claimed in claim 24, characterized in that the alloy layer comprises 25-50% by weight of Fe, 5-20% by weight of Si, optional further constituents, the contents of which are limited to a total of not more than 5.0% by weight, and aluminum as the balance, and/or the Al base layer comprises 1.0-15% by weight of Si, optionally 2-4% by weight of Fe, optionally up to 5.0% by weight of alkali metals or alkaline earth metals, optionally up to 10% of Zn and optional further constituents, the contents of which are limited to a total of not more than 2.0% by weight, and aluminum as the balance.

26. The flat steel product as claimed in claim 24, characterized in that a degree of dispersion D₂ of precipitates in the alloy layer is subject to the following condition:
$$25 \cdot {10}^{- 6} \frac{1}{nm} < {D}_{2} < 5 \cdot {10}^{- 3} \frac{1}{nm}$$

27. A process for producing a flat steel product for hot forming with an anticorrosion coating, comprising the following steps:
a) providing a slab or thin slab which is composed of steel comprising iron and in % by weight:
C: 0.25-0.8%,
Si: 0.01-2.0%,
Al: 0.001-1.0%,
B: 0.0005-0.01%,
P: ≤0.03%,
S: ≤0.02%,
N: ≤0.03%,
Sn: ≤0.03%,
As: ≤0.01%,
Sb: ≤0.02%, and
Unavoidable impurities, and
at least one of the elements in the group comprising Ti, Nb and V, with the proviso that the contents are as follows:
Ti: 0.008-0.10%,
Nb: 0.01-0.07%, and
V: 0.01-0.4%;
b) through-heating the slab or thin slab at a temperature (T1) of 1100-1320° C.;
c) prerolling the through-heated slab or thin slab to give a preliminary strip having a preliminary strip temperature (T2) of 800-1200° C.;
d) hot rolling the preliminary strip to give a hot-rolled flat steel product by means of a rolling mill, where the local temperature of the preliminary strip is adjusted before and during the hot rolling of the preliminary strip such that the temperatures of the individual sections of the preliminary strip do not vary by more than 60 K in the course of hot rolling and where the final rolling temperature (T3) is 750-910° C.;
e) cooling the hot-rolled flat steel product to a coiling temperature (T4) of 500-670° C.;
f) coiling the hot-rolled flat steel product;
g) descaling the hot-rolled flat steel product;
h) optionally cold-rolling the flat steel product, where the degree of cold rolling is at least 30%;
i) annealing the flat steel product at an annealing temperature (T5) of 650-900° C.;
j) cooling the flat steel product to an intermediate temperature (T6) of 650-800° C., preferably 670-800° C.;
k) optionally coating the flat steel product having an anticorrosion coating that has been cooled to the intermediate temperature by hot dip coating in a melt bath having a melt temperature (T7) of 660-800° C., preferably 680-740° C.;
l) cooling the flat steel product to room temperature, where the first cooling period t_{MT} in the temperature range between 600° C. and 450° C. is more than 10 s, especially more than 14 s, and the second cooling period t_{LT} in the temperature range between 400° C. and 300° C. is more than 8 s, especially more than 12 s;
m) optionally skin pass rolling the flat steel product.

28. The process as claimed in claim 27, wherein the steel comprises one or more of elements “Cr, Mn, Co, Cu, Mo, Ni, Ca, W, Ce, La” in the following contents:
Cr: 0.01-1.0%,
Mn: 0.01-3.5%,
Co: 0.05-1.0%,
Cu: 0.01-0.2%,
Mo: 0.002-1.0%,
Ni: 0.01-2.0%,
Ca: 0.0005-0.01%,
W: 0.001-1.0%, and
Ce+La: 0.01-0.03%.

29. The process as claimed in claim 28, wherein the element contents are subject to the following condition:
$$0.03 < {( Mo \cdot Cr \cdot Ti \cdot V \cdot Nb )}^{\frac{C}{5}} < 0.4$$

30. The process as claimed in claim 28, wherein the element contents are subject to the following condition:
$$N i + C r \leq 1.1$$

31. The process as claimed in claim 28, characterized in that, in the hot dip coating operation, a melt bath is used, containing the anticorrosive to be applied to the flat steel product in liquid form, comprising 0.1-15% by weight of Si, optionally 2-4% by weight of Fe, optionally up to 5% by weight of alkali metals or alkaline earth metals and optionally up to 15% of Zn and optional further constituents, the contents of which are limited to a total of not more than 2.0% by weight, and aluminum as the balance.

32. The process as claimed in claim 27 further comprises producing a shaped sheet metal part based on the flat steel product, comprising the following steps:
a) providing a sheet metal blank composed of the flat steel product;
b) heating the sheet metal blank such that the AC3 temperature of the blank is exceeded at least in part and the temperature Tᵢₙₛ of the blank on insertion into a forming tool provided for a hot press forming operation (step c)) is at least partly at a temperature above Ms+100° C. where Ms denotes the martensite start temperature;
c) inserting the heated sheet metal blank into a forming tool, where the transfer period tₜᵣₐₙₛ required for the removal from the heating device and the insertion of the blank is not more than 20 s, preferably not more than 15 s;
d) hot press forming the sheet metal blank to give the shaped sheet metal part, where the blank in the course of hot press forming is cooled to the target temperature T_{target} over a period tₜₒₒₗ of more than 1 s at a cooling rate rₜₒₒₗ of at least partly more than 30 K/s and optionally held at that temperature;
e) removing the shaped sheet metal part that has been cooled to the target temperature T_{target} from the tool.

33. A shaped sheet metal part formed from a flat steel product comprising a steel substrate composed of steel comprising iron and in % by weight:
C: 0.25-0.8%,
Si: 0.01-2.0%,
Al: 0.001-1.0%,
B: 0.0005-0.01%,
P: ≤0.03%,
S: ≤0.02%,
N: ≤0.03%,
Sn: ≤0.03%,
As: ≤0.01%,
Sb: ≤0.02%, and
unavoidable impurities, and
at least one of the elements in the group comprising Ti, Nb and V, with the proviso that the contents are as follows:
Ti: 0.008-0.10%,
Nb: 0.01-0.07%, and
V: 0.01-0.4%,
and one or more of the elements “Cr, Mn, Co, Cu, Mo, Ni, Ca, W, Ce, La” in the following contents:
Cr: 0.01-1.0%,
Mn: 0.01-3.5%,
Co: 0.05-1.0%,
Cu: 0.01-0.2%,
Mo: 0.002-1.0%,
Ni: 0.01-2.0%,
Ca: 0.0005-0.01%,
W: 0.001-1.0%,
Ce+La: 0.01-0.03%,
where a degree of dispersion D₁ of precipitates in the near-surface third of the steel substrate is subject to the following condition:
$$25 \cdot {10}^{- 6} \frac{1}{nm} < {D}_{1} < 5 \cdot {10}^{- 3} \frac{1}{nm} ,$$
and optionally an anticorrosion coating.

34. The shaped sheet metal part as claimed in claim 33, wherein the element contents are subject to the following condition:
$$0.03 < {( Mo \cdot Cr \cdot Ti \cdot V \cdot Nb )}^{\frac{C}{5}} < 0.4$$

35. The shaped sheet metal part as claimed in claim 33, wherein the element contents are subject to the following condition:
$$N i + C r \leq 1.1$$

36. The shaped sheet metal part as claimed in claim 33, wherein the shaped sheet metal part at least partly has a tensile strength of at least 1500 MPa, preferably at least 1750 MPa.

37. The shaped sheet metal part as claimed in claim 33, wherein the anticorrosion coating is an aluminum-based anticorrosion coating and comprises an alloy layer and an Al base layer.

38. The shaped sheet metal part as claimed in claim 33, characterized in that a degree of dispersion D₂ of precipitates in the alloy layer is subject to the following condition:
$$25 \cdot {10}^{- 6} \frac{1}{nm} < {D}_{2} < 5 \cdot {10}^{- 3} \frac{1}{nm}$$
